(19) United States
(12) Patent Application Publication
(10) Pub. No.: US 2011/0174784 A1
(43) Pub. Date: Jul. 21, 2011

(54) METHOD FOR GAS-SHIELDED ARC BRAZING OF STEEL SHEET

(76) Inventor: Toshikazu Kamei, Kai-shi (JP)

(21) Appl. No.: 13/120,085

(22) PCT Filed: Sep. 29, 2009
(86) PCT No.: PCT/JP2009/004994

§ 371 Date: Mar. 21, 2011

(30) Foreign Application Priority Data
Sep. 30, 2008 (JP) 2008-252696
Oct. 15, 2008 (JP) 2008-266722

(51) Int. Cl. B23K 9/16

(52) U.S. Cl. 219/74

(57) ABSTRACT

A method for gas-shielded arc brazing of a steel sheet; wherein a solid wire containing copper, as a main component, and aluminum is used in arc brazing of a steel sheet; and the method including periodically carrying out pulse droplet transfer and short circuit droplet transfer in arc brazing using, as a shielding gas, a mixed gas consisting of 0.03 to 0.3% by volume of oxygen gas and the remainder which is argon.

### TECHNICAL FIELD

The present invention relates to a method of gas-shielded arc brazing of a steel sheet.

This application claims priority on Japanese Patent Application No. 2008-252696 filed on Sep. 30, 2008 and Japanese Patent Application No. 2008-266722 filed on Oct. 15, 2008, the disclosure of which is incorporated by reference herein.

### BACKGROUND OF THE INVENTION

Arc brazing is a brazing method using an electric arc as a heat source. It is a joining method in which a metal or alloy having a melting point lower than that of a base metal to be joined is used as a filler material and joining is carried out by scarcely melting a base metal, and is commonly executed using a welding source sold for arc welding.

Arc brazing requires low heat input as compared with melt welding such as gas metal arc (GMA) welding. Accordingly, it generates less strain and enables joining of a joint with a large gap and is therefore suited for joining of thin sheets such as vehicle body parts.

Usually, arc brazing allows a work piece to scarcely melt and is therefore capable of realizing joining with less strain by low heat input. Since the joint strength is ensured at a contact surface between a sheet material and a deposited metal, it is necessary to sufficiently ensure a contact surface between an upper sheet and a deposited metal particularly in case lap joint used often in arc brazing is carried out. An arc brazing method that has conventionally been used had a problem that protruding beads with a narrow bead width are likely to be formed because of poor wettability of beads, thus making it difficult to sufficiently ensure a contact surface between an upper sheet and a deposited metal.

As a filler material used in arc brazing, a copper alloy wire is mainly used. A copper-silicon alloy containing silicon and/or manganese (CuSi type, melting point of 910 to 1,025° C.) and a copper-aluminum alloy containing aluminum (CuAl type, melting point of 1,030 to 1,040° C.) are commonly used.

A CuAl type wire has such a feature that the tensile strength (390 to 450 MPa) is higher than CuSi type tensile strength (330 to 370 MPa) and also glossy golden beads are obtained.

On the other hand, a CuSi type wire has a melting point lower than that of the CuAl type wire and is therefore suited for arc brazing using low-current short arc. It has such a feature that pits (pores opened to a surface of beads) and blow holes (pores that exist inside a weld metal), that are usually observed in arc welding, are less likely to be generated even when used for joining of surface-treated steel sheets such as zinc coated steel sheets.

Arc brazing requires a shielding gas so as to protect an electric arc from atmospheric air, similar to arc welding, and an argon gas is commonly used as the shielding gas.

Electrons are emitted from the place where an oxide of a molten pool of a base metal is present. However, when an argon gas inert to a shielding gas is used, oxygen forming the oxide is deficient and a cathode spot as a radiant spot of electrons is not stabilized, resulting in unstable generation of an arc thereby causing sputtering in which a molten metal scatters at the time of droplet transfer and also bead humping such as deterioration in stability of bead toe and bead width, and meandering bead.

Furthermore, when the argon gas is used for pulse arc that periodically increases or decreases of the size of a current, spread of an arc increases and a wire is melted and released. Therefore, there was a defect in that an arc voltage is likely to increase and input heat increases, and burn through arises.

When the argon gas is used, wettability of beads becomes poor, and a narrow bead width is likely to be produced. In the case of applying to joining of surface-treated steel sheets such as zinc coated steel sheets, wettability further deteriorates and humping beads are likely to be produced. Therefore, the bead width is likely to become narrow and also a contact area between a deposited metal and a base metal becomes narrow. As a result, execution at a high-current range is adopted so as to ensure the joint strength. However, there was a problem that further destabilization of an arc and generation of spatters occur.

An increase in a brazing speed is also one of factors that destabilize an arc in the same manner as in the case of arc welding. Therefore, it is difficult to increase brazing speed, and brazing is commonly executed in the range of less than 1.0 m/min. However, in the case of a joint that is likely to form a gap, it is necessary to execute at a still lower speed so as to ensure a deposited amount.

It has been proposed, as an arc brazing method of reducing spatters and bead humping generated by unstable arc, a method of stabilizing an arc by adding a given amount or more of an oxygen gas, a carbonic acid gas, and a hydrogen gas or a helium gas in a shielding gas (Japanese Unexamined Patent Application, First Publication No. Hei 9-248668, Japanese Unexamined Patent Application, First Publication No. 2007-83303, and Published Japanese Translation No. 2005-515899 of the PCT International Publication).

In order to improve the wettability of beads in metal inert gas (MIG) brazing, there has been proposed a wire in which a shell made of Cu that forms a wire is filled with a core material wire made of an Al-based material, and a combined wire containing Si, Mn and Nb therein and also containing metal powder of Cu and inevitable impurities filled in a jacket made of Cu (Japanese Unexamined Patent Application, First Publication No. Hei 6-226486, and Japanese Unexamined Patent Application, First Publication No. Hei 6-269985).

It is commonly known that the wettability of beads can be improved by using a pulse arc.

It is also commonly known that thinning of a wire and increase of a protrusion length of a wire are carried out, so as to reduce heat input without decreasing the amount of wire deposited.

Regarding pulse arc welding, the following method is known.

Japanese Unexamined Patent Application, First Publication No. Hei 8-309533 discloses a method of carrying out droplet transfer by short circuit during a base current period so as to realize low welding heat input of a pulse arc welding of a zinc coated steel sheet. Namely, when droplet transfer is carried out every 1 pulse cycle, a welding voltage is set so that most of droplet provided by 1 pulse-1 short circuit transfers during a base current period, by carrying out one time of droplet transfer, which is caused by short circuit, during a base current period of 1 pulse cycle.

According to the method, low welding heat input can be realized. However, droplet transfer is carried out only at the time of the generation of short circuit. Therefore, when arc brazing using a CuAl type wire is carried out using this method, there is a problem that generated spatters are large as compared with a conventional droplet transfer method using pulse arc.

There has also been proposed a welding process in which pulse droplet transfer in which droplets transfers by a pulse arc and mechanical short circuit droplet transfer by a forward/backward moving operation of a wire are periodically combined (Published Japanese Translation No. 2007-508939 of the PCT International Publication). This Published Japanese Translation No. 2007-508939 of the PCT Application discloses a method capable of adjusting and controlling heat input balance by using a welding process in which pulse droplet transfer and mechanical short circuit droplet transfer by a forward/backward moving operation of a wire are periodically combined.

In this method, in short circuit droplet transfer, a droplet formed at wire tip is brought into contact with a molten pool by a forward moving operation of a wire (wire feed direction is the side of the member to be joined) and then the droplet is released from the wire by carrying out a backward moving operation of the wire (inversion of a wire feed direction). Therefore, heat input in this section is reduced and also the generation of spatters at the time of droplet transfer is suppressed. However, this method had a problem that behavior of an arc cannot be controlled and the generation of spatters caused by a phenomenon, wherein an arc is unstable, cannot be prevented.

The method disclosed in aforementioned Japanese Unexamined Patent Application, First Publication No. Hei 9-248668 proposes that a shielding gas containing 2 to 10% of oxygen in an argon gas is used so as to prevent spatters caused by unstableness of an arc and the generation of burn through.

However, this method had a problem that the generation of spatters caused by a phenomenon, wherein an arc is unstable, can be prevented but spatters caused by oxidation of beads cannot be prevented

According to the above method, droplet transfer can be smoothly carried out by shortening the arc length. However, as compared with the case of only an argon gas, an arc voltage decreases and an arc is concentrated.

Therefore, in case a pulse arc is carried out, a bead width decreases and thus stability of the bead toe deteriorates. Therefore, allowance regarding a gap decreases and target missing tends to occur, thus making it difficult to realize speed-up. Furthermore, since beads undergo severe oxidation by an oxidizing gas component in a shielding gas, golden beads, which is generally obtained by using a CuAl type wire, undergoes discoloration to a black color, and also wrinkles are generated on beads to cause problems in corrosion resistance and appearance.

Also, the present inventors have carried out arc brazing of a zinc coated steel sheet by a consumable electrode type arc welder used commonly in arc brazing, using such a gas. As a result, it has been found that it is impossible to improve wettability of beads to a satisfactory level, although a phenomenon of an unstable arc is improved and thus a spatter generation amount decreases, as shown in Test Example described hereinafter.

On the other hand, Published Japanese Translation No. 2005-515899 of the POT Application discloses a method for braze welding of a zinc coated metal part using a gas mixture consisting of 0.4 to 2.0% hydrogen and 0.3 to 2.0% of carbon dioxide with the remainder including argon.

However, hydrogen is added to this gas mixture. Commonly, use of a shielding gas containing hydrogen added therein is not preferred in arc welding of a steel sheet because of anxiety of the generation of weld crack. It is concerned that cracks are caused by using such a gas mixture even in arc brazing of a steel sheet. Also, this gas mixture is a gas prepared by mixing three kinds of gasses and therefore the costs are increased.

Furthermore, thinning of a wire for the purpose of a reduction in heat input as described above causes an increase in wire cost. When the wire protrusion length is elongated, there arises a defect that target missing of a wire relative to a join line is likely to occur.

Furthermore, since the combined wire for MIG brazing disclosed in aforementioned Japanese Unexamined Patent Application, First Publication No. Hei 6-226486 and Japanese Unexamined Patent Application, First Publication No. Hei 6-269985 is a special wire, there is a problem that the cost of a filler material increases as compared with the case of using a solid wire that is entirely homogeneous.

By the way, in consumable electrode type arc brazing using a consumable electrode that is melted in an arc, brazing is commonly executed using a short arc (short circuit arc) or pulse arc.

The short arc is an arc form in which droplets are transferred while alternately repeating ignition (generation) of an arc and disappearance by short circuit, and is often used in arc brazing of a thin steel sheet. In case a thin steel sheet is subjected to arc brazing by a short arc using a common welding source, brazing is executed in a low current and low voltage range so as to prevent burn through.

In a short arc with a common form in which a wire is always fed in a workpiece direction, droplets are formed by ignition of the arc, and the arc disappears as a result of contact short circuit of droplets to the object to be joined, workpiece or molten pool, whereby, the droplets undergo an electromagnetic pinch force and a thermal pinch force, thus carrying out short circuit droplet transfer in which droplets are released from a wire.

At this time, the magnitude of the electromagnetic pinch force depends on a current value. The magnitude of the thermal pinch force depends on a ratio of a carbonic acid gas, an oxygen gas, or the like, that have a large effect of cooling an arc and is used for pinching an arc, in a shielding gas. In case arc brazing of a thin steel sheet is carried out by a short arc, arc brazing is carried out in a low current range as described above and, as a result, the electromagnetic pinch force becomes weak, thus making it impossible to avoid the occurrence of spatters at the time of short circuit.

Also, in case a CuAl type wire is used in arc brazing, addition of an oxidizing gas is limited from the viewpoint of prevention of oxidation of beads. Therefore, there is a problem that the effect of a thermal pinch force cannot be expected and the generation of spatters becomes severe.

In a common short arc in which droplet transfer depending on a pinch force is carried out, protruding beads with a narrow bead width are likely to be formed, and also the bead toe portion and the bead width are likely to become non-uniform. Therefore, there is a problem that a tolerance to target missing of the wire becomes narrow.

On the other hand, the pulse arc is an arc form in which a peak current higher than a critical current and a low base current lower than a critical current are periodically added thereby melting a wire in a peak current period, and then droplets formed at wire tip are transferred to a molten pool in a pulse fall period, in which a peak current transfers to a base current, and a base period. Droplets are transferred to a molten pool without being brought into contact with the molten pool by a wire or the like. The above critical current means a limiting current of spray transfer. According to the pulse arc, a wire is melted to form a droplet by one-time pulse peak current, and then droplet is transferred to a molten pool in a pulse fall period, in which a peak current transfers to a base current, and a base period. In this way, droplet transfer becomes 1 transfer per 1 pulse by adjusting pulse conditions, thus making it possible to reduce the generating degree of spatters. It is possible to obtain wide beads having satisfactory wettability of beads as compared with a short arc because of a large spread of the arc.

Commonly, in joining of thin sheet parts in which arc brazing is often used, since the sheet has a small sheet thickness, a gap is likely to form at the joint after joining. Also, in a vehicle assembly line or the like employing automatic welding such as a robot, target missing is likely to arise with respect to a target weld line due to strain generated at the time of member assembling, and therefore, “no gap bridging”, in which sheets cannot be joined, is likely to arise. In order to suppress defects caused by these phenomena, the feed amount (deposited amount) of the wire is commonly increased by increasing the welding current. However, since heat input amount also increases, melting of the base metal cannot be avoided.

Therefore, in case arc brazing of a joint of a thin steel sheet having small heat capacity, when a pulse arc is used, both a current value and a voltage value increase as compared with a short arc. Therefore, there is a problem that heat input is likely to increase and “burn through” in which holes are opened in a joint by excessive heat input is likely to arise.

Burn through and no gap bridging lead to increased rework cost, which is unfavorable. Therefore, it has been considered that it is not suitable for a thin steel sheet to use a pulse arc in which heat input into a base metal is likely to become excessive. Particularly, burn through of a thin steel sheet sometimes makes it difficult to rework the thin steel sheet, and thus execution conditions free from burn through have been required over a long period of time.

### PRIOR ART DOCUMENTS PATENT DOCUMENTS

### Patent Document 1

Japanese Unexamined Patent Application, First Publication No. Hei 9-248668

### Patent Document 2

Japanese Unexamined Patent Application, First Publication No. 2007-83303

### Patent Document 3

Published Japanese Translation No. 2005-515899 of the PCT International Publication

### Patent Document 4

Japanese Unexamined Patent Application, First Publication No Hei 8-309533

### Patent Document 5

Published Japanese Translation No. 2007-508939 of the PCT International Publication

### Patent Document 6

Japanese Unexamined Patent Application, First Publication No. Hei 6-226486

### Patent Document 7

Japanese Unexamined Patent Application, First Publication No. Hei 6-269985

### SUMMARY OF INVENTION

### Problem to be Solved by the Invention

An object of the first aspect of the present invention is to prevent the generation of spatters caused by an unstable arc phenomenon, the generation of bead irregularity due to excessive concentration of arc, the generation of discoloration due to oxidation of a surface of beads and the generation of wrinkles of beads, and also to prevent burn through and no gap bridging due to the generation of gap and target missing in a consumable electrode type arc brazing method of a steel sheet.

An object of the second and third aspects of the present invention is to improve the wettability of beads without using a special combined wire and to prevent the generation of irregular beads typified by humping and meandering bead, and also to reduce the generation of spatters to obtain flat beads having a uniform bead width in consumable electrode type arc brazing of a steel sheet.

### Means for Solving the Problems

In order to achieve the above objects, the following aspects of the present invention are provided.

(1) The first aspect of the present invention is a method of gas-shielded arc brazing of a steel sheet; wherein a solid wire containing copper, as a main component, and aluminum is used in arc brazing of a steel sheet; and the method including

periodically carrying out pulse droplet transfer and short circuit droplet transfer in arc brazing using, as a shielding gas, a mixed gas consisting of 0.03 to 0.3% by volume of oxygen gas and the remainder which is argon.

(2) In the first aspect (1) of the present invention, it is preferred that the pulse droplet transfer (three or more times) and the short circuit droplet transfer (one time) are periodically carried out as one cycle, and a pulse fall time from a peak current to a base current is from 3.1 to 8.4 ms.
(3) In the inventions of (1) and (2), it is preferred that the gas-shielded arc brazing is carried out at a joint in which two or more sheet materials are laid one upon another, and a target position of a wire is set within a range between the point that is 1 mm apart from the intersection point toward the lower sheet side and the point that is 2 mm apart from the intersection point toward the upper sheet side, wherein the intersection point is a point where the perpendicular drawn from an upper sheet end of a sheet material located on the uppermost side of sheet materials laid one upon another meets a top surface of a lower sheet located on the lowermost side of the sheet materials.
(4) In the inventions of (1) and (2), it is preferred that the gas-shielded arc brazing is carried out at a joint in which two or more sheet materials are laid one upon another, and a gap between sheet materials is set to 2.0 mm or less, or a gap between sheet materials is two times or less a sheet thickness of the lower sheet material located on the lowermost side of the joint.
(5) In the inventions of (3) and (4), it is preferred that a heat input amount is set within a range of from 700 to 1,800 J/cm.
(6) The second aspect of the present invention is a method of gas-shielded arc brazing of a steel sheet; wherein
a copper alloy wire containing copper, as a main component, silicon and manganese is used in the gas-shielded arc brazing; and the method including
periodically carrying out short circuit droplet transfer by a forward/backward moving operation of the wire relative to a workpiece in arc brazing using, as a shielding gas, a mixed gas consisting of 1.5 to 7% by volume of an oxygen gas and the remainder which is an argon gas.
(7) The third aspect of the present invention is preferably a method of gas-shielded arc brazing of a steel sheet; wherein
a copper alloy wire containing copper, as a main component, and silicon and manganese is used in the gas-shielded arc brazing; and the method including
periodically carrying out short circuit droplet transfer by a forward/backward moving operation of the wire relative to a workpiece in arc brazing using, as a shielding gas, a mixed gas consisting of 2 to 7% by volume of an oxygen gas, 15% by volume or less of a helium gas and the remainder which is an argon gas.
(8) In the inventions of (6) and (7), it is preferred that the argon gas is a crude argon gas containing an oxygen gas and a nitrogen gas as impurities.
(9) In the inventions of from (6) to (8), it is preferred that the number of short circuits per second in the short circuit droplet transfer is set within a range of from 55 to 85 times.
(10) In the inventions of from (6) to (7), it is preferred that the copper alloy wire is a solid wire having a cross-section that is solid and is homogeneous.
(11) The inventions of from (6) to (10) are preferably a method for gas-shielded arc brazing of a joint in which steel sheets are laid one upon another, wherein a heat input amount Q satisfies the following conditional expression determined according to a sheet thickness of a steel material to be joined:

625×t+125≦Q≦1,250×t+250 (J/cm)

where t is a sheet thickness (mm) of a steel sheet.
(12) In the invention of (11), it is preferred that an average welding current is from 60 to 150 A.
(13) In the invention of (11), it is preferred that the steel sheet has a sheet thickness of 0.6 to 1.4 mm.
(14) In the inventions of from (6) to (13), it is preferred that the steel sheet is a zinc coated (galvanized) steel sheet.

### Effects of Invention

According to the arc brazing method of the first aspect of the present invention, it is possible to prevent an unstable arc phenomenon thereby reducing the generation of spatters in not only low-speed arc brazing but also high-speed arc brazing. Also, it is possible to prevent excessive concentration of an arc and to reduce an arc voltage, and also to form beads having a uniform toe and to withstand gap of sheets and target-missing, thus making it possible to realize a reduction in generation of burn through and no gap bridging. It is also possible to realize these effects and speed-up arc brazing. It is further possible to prevent discoloration of beads due to oxidation of a surface of beads, and to prevent the generation of wrinkles.

According to the arc brazing method of the second and third aspects of the present invention, it is possible to improve the stability of arcs and to reduce spatters. Since not only the effect but also the wettability of beads are improved, flat beads can be obtained, thus making it possible to prevent the generation of irregular beads typified by humping and meandering bead.

### BRIEF DESCRIPTION OF DRAWINGS

FIG. 1 is a schematic configuration diagram showing an example of an arc brazing method of the present invention.

FIG. 2 is a timing chart showing a waveform of a welding current, a change in voltage, a state of droplet transfer and a movement of a wire used in the present invention.

FIG. 3 is a configuration diagram showing an example of a target position of a wire in the present invention.

FIG. 4 is a configuration diagram showing the joint configuration and a target position of a torch in Test Example 1.

FIG. 5 is a configuration diagram showing the joint configuration and a target position of a torch in Test Example 2.

FIG. 6A is a photograph showing appearance of a joining portion obtained using a sample No. 45 of Test Example 1.

FIG. 6B is a photograph showing the appearance of a joining portion obtained using a sample No. 49 of Test Example 1.

FIG. 7A is a photograph showing appearance of a joining portion obtained using a sample No. 86 of Test Example 2.

FIG. 7B is a photograph showing the appearance of a joining portion obtained using a sample No. 89 of Test Example 2.

FIG. 8A is an explanatory diagram schematically showing the form of a short circuit droplet transfer of the present invention.

FIG. 8B is an explanatory diagram schematically showing the form of a conventional short circuit droplet transfer.

FIG. 9A is an explanatory diagram for evaluating bead wettability in the Test Examples.

FIG. 9B is an explanatory diagram for evaluating bead wettability in the Test Examples.

FIG. 90 is an explanatory diagram for evaluating bead wettability in the Test Examples.

FIG. 10A is a graph showing a current and a voltage waveform at the time of arc brazing in a test No. 9 in the Test Examples.

FIG. 10B is a graph showing a current and a voltage waveform at the time of arc brazing in a test No. 12 in the Test Examples.

FIG. 11A is a graph showing a current and a voltage waveform at the time of arc brazing in a test No. 1 in the Test Examples.

FIG. 11B is a graph showing a current and a voltage waveform at the time of arc brazing in a test No. 5 in the Test Examples.

FIG. 12A is an explanatory diagram showing a joined state of a deposited metal and a base metal in the Test Examples.

FIG. 12B is an explanatory diagram showing a joined state of a deposited metal and a base metal in the Test Examples.

### BEST MODE FOR CARRYING OUT THE INVENTION

Preferred examples according to the first to third aspects of the present invention will be described with reference to the accompanying drawings. However, the present invention is not limited only to these examples. Various modifications of positions, numbers, sizes, amounts and the like can be made without departing from the scope of the present invention.

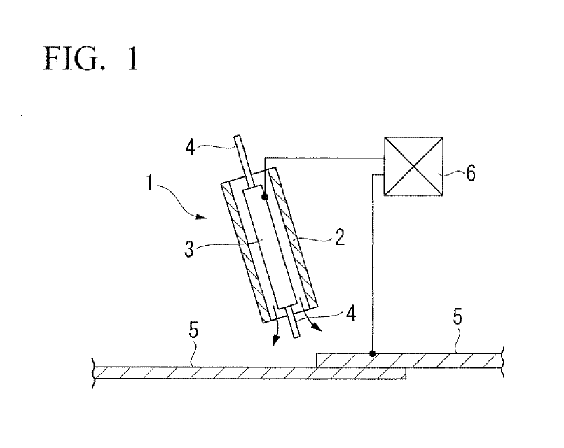

FIG. 1 is a schematic configuration diagram showing an example of a brazing method used in the first to third aspects of the present invention. In FIG. 1, a reference sign 1 denotes a welding torch. This welding torch 1 is composed of a gas nozzle 2 and a contact chip 3.

The gas nozzle 2 is hollow cylindrical and a coaxially hollow cylindrical contact chip 3 is inserted and fixed into the interior of the gas nozzle while leaving a gap.

The gap between the gas nozzle 2 and the contact chip 3 serves as a passage through which a shielding gas flow. This passage is connected to a shielding gas feed source (not shown), from which the shielding gas is fed.

A wire 4 that would serve as a consumable electrode is inserted into a cavity in the contact chip 3. From a wire feed device (not shown), the wire 4 is automatically fed and continuously fed from the contact chip 3.

This wire feed device can carry out a forward moving operation of feed the wire 4, and a backward moving operation that slightly backspaces the wire 4. The number of times per time, cycle, timing and movement amount of the wire 4 of a forward moving operation and a backward moving operation can be appropriately set.

Also, a welding current is applied between a contact chip 3 and base metals 5 from the welding power source device 6. By this welding current, an arc is generated between wire 4 and base metals 5. The wire 4 is melted by this arc to form droplets. The droplets are transferred to the base metals 5 and flow into a gap of the base metals 5, where joining (brazing) of the base metals 5 is carried out.

(Method for Gas-Shielded Arc Brazing of a Steel Sheet According to the First Aspect)

The first aspect of the present invention relates to a method of arc brazing of a steel sheet using a copper-aluminum alloy wire containing copper, as a main component, and aluminum. According to this method, generation of spatters and bead irregularity (non-uniformity of a bead width) at the time of high-speed brazing are suppressed, and also the occurrence of burn through and no gap bridging at the time of the generation of gap and target missing is prevented.

In the method for gas-shielded arc brazing of a steel sheet according to the first aspect, as the shielding gas, a mixed gas consisting of 0.03 to 0.3% by volume, preferably 0.05 to 0.18% by volume of an oxygen gas with the remainder which is argon is used. This argon does not mean crude argon. When the amount of oxygen is less than 0.03% by volume, the arc may become unstable, and spatters tend to be generated and bead width may become non-uniform. When the amount of oxygen is more than 0.3% by volume, since severe bead oxidation and extreme concentration of an arc occurred, and a bead width becomes narrow and, as a result, excessive molten metal may scatter as spatters and the bead width may become uniform.

The flow rate of the shielding gas is preferably from about 10 to 30 liter/min, and more preferably from 10 to 20 liter/min, but is not limited to the above range.

In the first aspect, as the wire 4, a solid wire containing copper, as a main component, and aluminum is used. The wire can also contain other components. The diameter of the wire can be optionally selected, and a solid wire (filled-core type wire) having a diameter of 0.8 to 1.2 mm of a copper alloy containing copper, as a main component, and aluminum is preferably used. The composition of the wire can also be optionally selected, and the content of aluminum is preferably from 7 to 8% by weight. Specifically, a copper alloy wire (CuAl8) in which the amount of aluminum defined in EN14640:2005 is within a range of from 6.0 to 9.5% by weight is preferably used. The feed speed of the wire 4 can be selected based on the required deposited amount and is preferably within a rage from 3 to 20 m/min, and more preferably from 4 to 8 m/min, but is not limited to be within the above range.

In the first aspect, as the base metal 5, steel sheets such as a carbon steel sheet and a stainless steel sheet are used. The sheet thickness is not particularly limited, and is preferably from about 0.6 to 3.2 mm, and more preferably from 0.6 to 2.3 mm. Lap joint may be mainly used as the joint shape, but is not limited thereto. There is also no limitation on the number of the base metal used in the method. The gap between two base metals 5 is preferably within a range from about 0 to 3 mm.

The surface-treated steel sheets such as a zinc coated steel sheet are excluded from the steel sheet used in the first aspect of the present invention.

As the welding current used in the first aspect of the present invention, a DC pulse current is used.

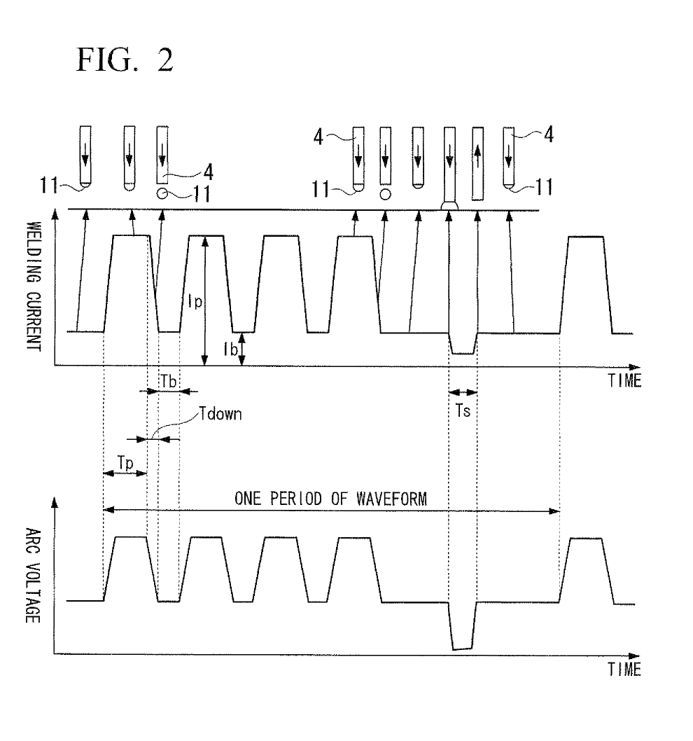

FIG. 2 is a timing chart showing a welding current, an arc voltage, movement of a wire 4, and a transfer state of droplets 11 in the first aspect of the present invention. Also, the welding current and the arc voltage are schematically shown.

In the first aspect of the present invention, for example, as shown in FIG. 2, the pulse droplet transfer (preferably three or more times, and more preferably 3 times to 8 times (4 times in example shown in the drawing)) and the short circuit droplet transfer (one time) are combined as one cycle. The first aspect is characterized in that droplet transfer is carried out by periodically repeating the cycle. The number of times of pulse droplet transfer is not limited in the first aspect of the present invention, and a preferred number of times may be selected.

The pulse droplet transfer refers to the following transfer of droplets. As shown in FIG. 2, formation of droplets 11 starts from a base current Ib (a base current flow), and then droplets are formed during a peak current Ip is being continued. Thereafter, droplets 11 are dropped on (transferred to) a molten pool or an object to be welded during the time of a pulse fall time (Tdown) wherein the current returns from the peak current Ip to the base current Ib. As described above, droplet transfer, which occurs once every 1 pulse waveform, refers to pulse droplet transfer.

When the repeated number of times of pulse droplet transfer is less than 3 times, the feed amount of the wire 4 decreases and it is sometimes impossible to ensure the deposited amount required to form stable beads. On the other hand, when the repeated number is more than 8 times, since the number of pulses during 1 cycle may increase, resulting in excessive heat input. As a result, there is a possibility that heat input reducing effect due to the short circuit droplet transfer, i.e. effect of reducing heat quantity to be imparted to the weld zone from the outside cannot be obtained.

The short circuit droplet transfer refers to the following transfer of droplets. As shown in FIG. 2, during the base current time Tb, the wire 4 is fed at a speed higher than before at the time when formation of a droplet 11 proceeded to some extent. By feeding, a droplet 11 at tip of the wire 4 is brought into contact (short circuit) with the object to be welded and then the droplet 11 is transferred to a molten pool. Thereafter, the wire 4 is backspaced by a given range. During transfer of the droplets, a peak current is not applied. Execution of droplet transfer as described above refers to short circuit droplet transfer.

During short circuit droplet transfer time Ts wherein contact and backspace of the wire in this short circuit droplet transfer are carried out, the welding current and the arc voltage decrease, and thus a heat input amount decreases.

In a pulse waveform of the present invention, the pulse fall time (Tdown) wherein the current returns from the peak current Ip to the base current Ib is preferably set to be within a range of from 3.1 to 8.4 ms.

When the fall time Tdown is less than 3.1 ms, there is a possibility that the subsequent pulse is applied before droplets 11 formed at the wire 4 tip are smoothly dropped (transfer) in a molten pool, and that an unstable arc phenomenon and the generation of spatters may occur.

On the other hand, when a pulse fall time Tdown is more than 8.4 ms, a brazing speed increases due to an increase in the transfer distance of droplets, resulting in irregular droplet transfer, and thus short circuit and bead irregularity are likely to occur.

By adjusting the pulse fall time Tdown within the above range, pulse droplet transfer is preferably carried out during the section of pulse fall time Tdown, and stable droplet transfer is achieved even when the base current time Tb is short.

Also, the average welding current is preferably set within a range from 70 to 150 A, and the peak current Ip is preferably set within a range from 360 to 420 A. The base current Ib is preferably set within a range of from 20 to 70 A. The pulse time Tp is preferably set within a range of from 1.0 to 1.8 ms. When the welding current condition are lower than these ranges, there is a possibility that the wire feed amount becomes small and the deposited amount becomes insufficient, and also the arc becomes unstable. Therefore, sputtering and the generation of bead irregularity may occur. When the welding current conditions are higher than the above range, there is a possibility that melting of the wire becomes excessive and droplet transfer becomes unstable, and also heat input becomes excessive, and thus burn through is likely to occur when a gap is formed.

The movement speed, e.g. the brazing speed of the welding torch 1 is optionally selected, and is preferably 3 m/min or less so as to prevent instabilization of an arc. In the case of a joint that causes gap and target missing, it is necessary to execute brazing at a lower speed. Therefore, the brazing speed is preferably set within a range of from about 0.8 to 1.5 m/min, practically.

It becomes possible to realize an operation of repeating a combination of pulse droplet transfer (3 to 8 times) and short circuit droplet transfer (one time) by a control of a welding current waveform from a welding source device 6 and a control of feed of a wire 4 by a wire feed device. For example, in the present invention, a combination of pulse droplet transfer and short circuit droplet transfer may be continuously carried out without interval, or a combination of pulse droplet transfer and short circuit droplet transfer may be carried out every predetermined given time.

The welding joint will be described below. In the present invention, it is possible to employ a target position of a member to be welded widely and stably, wherein the target position is aimed by the wire 4, by carrying out an operation of periodically repeating the above combination of pulse droplet transfer (3 to 8 times) and short circuit droplet transfer (one time).

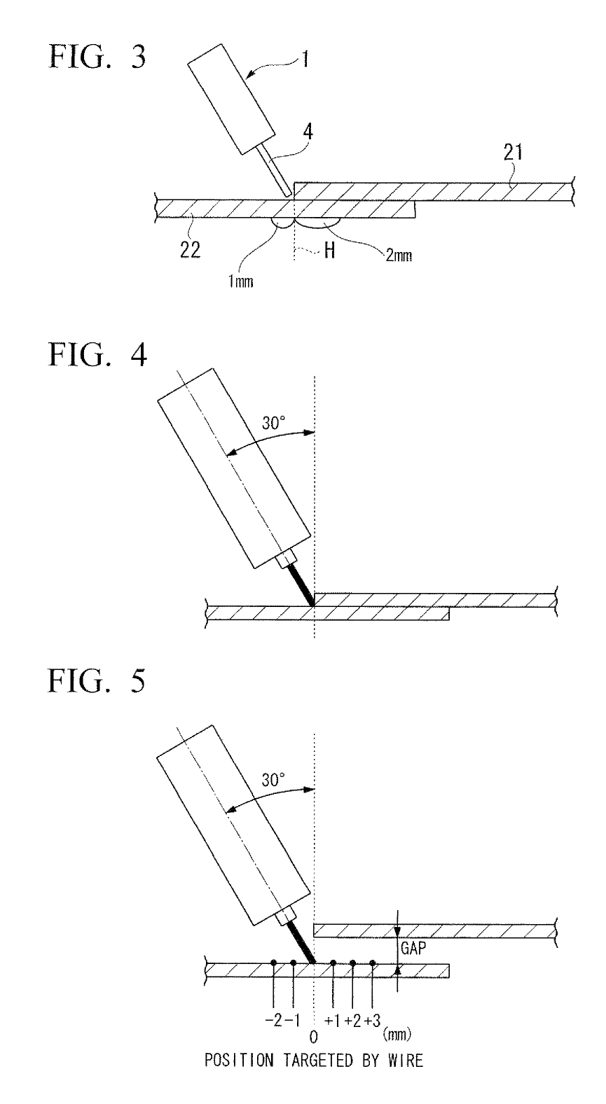

In case a joint constituted from two or more sheet materials laid one upon another, such as a lap joint or a joggled lap joint, is used as an object to be welded, as shown in FIG. 3, a target position of a wire 4 can be determined. For example, when viewed from a cross-section, a target position of a wire 4 can be set within a range between the point that is 1 mm apart from the intersection point toward the lower sheet side (left side of the drawing) and the point that is 2 mm apart from the intersection point toward the upper sheet side (right side of the drawing) from side to side. Said intersection is a point where the perpendicular H, which is drawn from a sheet end of a sheet material 21 located on the uppermost side of a laminate which includes two or more sheet materials, here, the laminate is two sheet materials 21 and 22, meets a top surface of a sheet 22 located on the lowermost side of the laminate.

In the present invention, it is also possible to widely employ a gap between sheet materials. In the case of a joint in which two or more sheet materials are laid one upon another, it is preferred that a gap between sheets is set to 2.0 mm or less, or to a value that is two or less times a sheet thickness of the lower sheet which is located on the lowermost side of the joint. In the case of an arc brazing wherein a lap joint of a thin steel sheet having a sheet thickness of 0.6 to 1.0 mm is performed, when a gap is set to a sheet thickness or more of a sheet material located on the lowermost side of the joint, the gap is preferably set to be within a range from 0.6 to 2.0 mm, or the value that is 1 to 2 times a sheet thickness of the lower sheet located on the lowermost side of the joint.

The heat input to be applied at the time of arc brazing is preferably set within 700 to 1,800 J/cm, and the wire feed amount is preferably set to be within a range from 20 to 45 g/m per 1 m of beads. When the heat input and the wire feed amount deviate from the above ranges, burn through and/or no gap bridging may occur due to insufficient wire deposited amount, lack of heat input to a base metal, or excessive heat input to a base metal.

The reason of limitation to the shielding gas composition according to the first aspect of the present invention will be described below based on the consideration derived from the results of specific examples described hereinafter.

In the gas-shielded arc brazing method according to the first aspect of the present invention, when an oxidizing gas is added in a shielding gas, a cathode spot of a base metal is stably formed and concentricity of an arc increases, and also the arc voltage decreases. Therefore, an arc unstable phenomenon typified by meandering bead is improved and tolerance of target missing is widened, and also the effect capable of preventing burn through due to excessive heat input can be obtained. Therefore, the deposited amount of the wire can be increased, and also the effect of widening a tolerance to the generation of a gap is obtained.

On the other hand, when an oxidizing gas is added in more than the required amount, an arc is excessively concentrated. Therefore, excessively fed molten metal scatters as spatters, and thus the bead width becomes narrow and also tolerance to target missing is reduced. There is a problem that a surface of beads undergoes discoloration by oxidation. Therefore, in arc brazing using a CuAl type wire, it is not preferred to excessively add an oxidizing gas.

As a result of examination, in the method according to the first aspect of the present invention, in case oxygen is used as an addition gas, the minimum concentration of oxygen is preferably 0.03% by volume and the upper limit of oxygen concentration is preferably 0.3% by volume.

(Method for Gas-Shielded Arc Brazing of a Steel Sheet of Second and Third Aspects)

The second to third aspects of the present invention relate to a method for arc brazing of a steel sheet using a copper-silicon alloy wire containing copper, as a main component, and silicon and manganese. According to this method, it is possible to improve the wettability of beads and to prevent the generation of irregularity of beads typified by humping and meandering bead, and also to reduce the amount of spatters, thus obtaining flat beads having uniform bead width.

In the method for gas-shielded arc brazing of a steel sheet according to the second aspect, a mixed gas consisting of 1.5 to 7% by volume, and preferably 2 to 7% by volume, of an oxygen gas with the remainder including argon gas and inevitable impurities is used as a shielding gas. The amount of inevitable impurities is preferably 0.1% by volume or less.

Herein, when the amount of oxygen gas is less than 1.5% by volume, since a cathode spot is not stably formed and an arc becomes unstable, bead irregularity typified by humping and meandering bead are likely to occur. Also, it is impossible to improve the wettability of beads to a satisfiable level because of a large spread of an arc and lack of heat input to a base metal. When the amount is more than 7% by volume, since an arc is excessively concentrated, the stability of the bead width may deteriorate. Since oxidizability becomes excessive, a slag as a non-metal substance generated at the weld zone is generated in a large amount, and also a large amount of dust due to peeling tends to be generated.

In a method for gas-shielded arc brazing of a steel sheet according to the third aspect, a mixed gas consisting of 2 to 7% by volume of an oxygen gas and 15% by volume or less of a helium gas with the remainder including argon gas and inevitable impurities is used as a shielding gas. Use of the mixed gas enables suppression of spread of an arc and improved bead wettability. When the amount of a helium gas is more than 15% by volume, droplets are not transferred by short circuit and are continuously released from the wire, like the case of spray transfer. Therefore, when a torch movement speed (brazing speed) is increased, an arc becomes unstable and a bead width is likely to become non-uniform, and also spatters are likely to be generated. In the present aspect, the lower limit of the helium gas can be optionally selected, and the lower limit is preferably 5% by volume or more. When the amount of helium gas is 5% by volume or more, the expected effects can be sufficiently obtained

Herein, inevitable impurities are a trace amount of other components contained in the case of producing a gas. The argon gas and helium gas in the present invention also include those containing inevitable impurities.

The argon gas contained in the mixed gas may be an argon gas (a crude argon gas) containing an oxygen gas and a nitrogen gas as impurities as long as it does not depart from the scope of the present application. The amount of the nitrogen gas in the argon gas is preferably set to 0.1% by volume or less.

The gas used in the present invention can be obtained by an air liquefaction separation apparatus that rectifies and separates each component by a difference in a boiling point of each component of air after liquefaction of air. An argon gas is obtained by an air liquefaction separation apparatus equipped with an argon gas collecting step.

The amount of the argon gas in air is less than 1%, and the boiling point thereof is a value between the boiling point of the nitrogen gas and the boiling point of the oxygen gas. Therefore, the argon gas is obtained by passing through the steps of extracting crude argon containing argon, oxygen and nitrogen using the air liquefaction separation apparatus, and then removing impurities.

To the crude argon extracted from the air liquefaction separation apparatus, hydrogen is added so as to remove an oxygen component, and oxygen is removed as water by a catalyst. Thereafter, the deoxidized crude argon gas containing a small amount of a nitrogen gas and a hydrogen gas is rectified to remove the nitrogen gas and the hydrogen gas, thus obtaining pure argon that is commonly called argon.

The cost of the argon gas is high because of its complicated production process. On the other hand, the crude argon gas is inexpensive compared with the pure argon gas, since it is produced without being passed through the deoxidation and rectification steps.

In the second and third aspects of the present invention, such a crude argon gas can be used as the argon gas. In case a shielding gas is prepared using the same, the entire oxygen content in the shielding gas is adjusted to the value defined above. It is preferred that the amount of the nitrogen gas in the shielding gas is adjusted to 0.1% by volume or less.

The flow rate of the shielding gas is preferably from about 10 to 30 liter/mine, and more preferably from 10 to 20 liter/min. However, the flow rate is not limited to this range in the present invention.

In the second and third aspects of the present invention, a copper alloy wire containing copper, as a main component, and silicon and manganese are used as the wire 4. Namely, the wire is composed of copper as a main components, silicon and manganese. The wire can contain other components. The diameter of the wire can be optionally selected, and a copper-silicon alloy wire having a diameter of 0.8 to 1.2 mm, containing copper, as a main component, and containing silicon and manganese is preferably used. The composition of the wire can also be optionally selected, and it is possible to preferably use a copper alloy wire (CuSi3Mn1) with the composition defined in EN14640:2005 in which the amount of silicon is from 2.8 to 4.0% by weight and the amount of manganese is from 0.5 to 1.5% by weight, the remainder including copper. This copper alloy wire is a solid wire made of the above copper alloy, which has a cross-section that is solid and is entirely homogeneous.

The feed speed of the wire 4 can be selected based on a required deposited amount, and is preferably within a range of from 3 to 11 m/min, and more preferably from 4 to 7 m/min, but is not limited to the above range.

In the second and third aspects of the present invention, a zinc coated steel sheet can be mainly used as the base metal 5, and the other surface-treated steel sheet and a carbon steel sheet that is not subjected to a surface treatment can also be used. There is no limitation on the sheet thickness. The sheet thickness is commonly from about 0.5 to 2.0 mm, preferably from about 0.6 to 1.4 mm, and more preferably from 0.6 to 1.0 mm. A lap joint is mainly used as the joint shape, but is not limited thereto. The gap between two base metals 5 is preferably from about 0 to 3 mm.

The arc brazing method according to the second and third aspects of the present invention is a method of carrying out short circuit droplet transfer. Unlike the conventional short circuit droplet transfer in which the wire only move forward, the present invention is characterized in that short circuit droplet transfer is periodically carried out by carrying out a forward/backward moving operation relative to a workpiece of the wire 4.

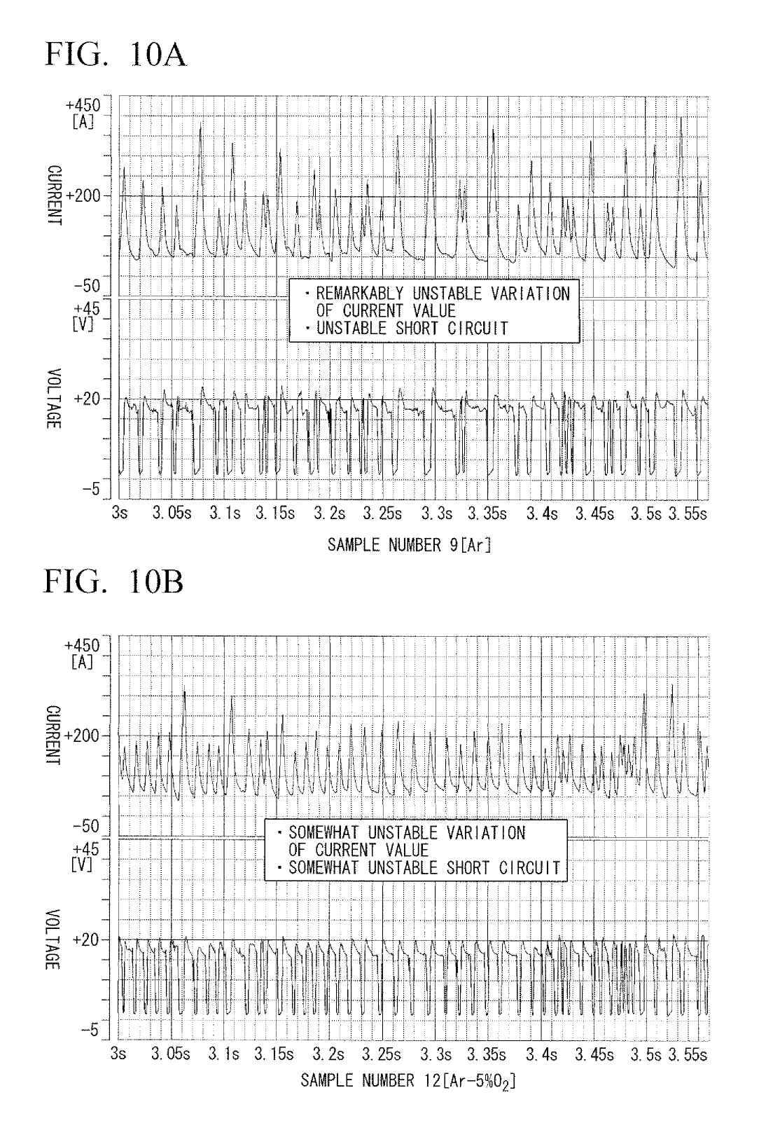

FIGS. 8A and 8B show the form of a short circuit droplet transfer according to the second and third aspects of the present invention, and the form of a conventional short circuit droplet transfer.

The form shown in FIG. 8A shows the form of a short circuit droplet transfer to be carried out in the present invention, while the form shown in FIG. 8B shows the form of a conventional short circuit droplet transfer.

As shown in FIG. 8A, in the short circuit droplet transfer of the present invention, when a droplet 11 is formed at a tip of the wire 4, the feed amount of the wire 4 is temporarily increased and the droplet 11 at a tip of the wire 4 is brought into contact with a molten pool or a workpiece thereby undergoing short circuit, followed by arc distinction. Thereafter, the wire 4 is backspaced to the predetermined position so that the wire 4 is pulled up and, at the same time, droplets 11 are transferred to a molten pool or a workpiece. Thereafter, an arc is ignited to form the subsequent droplet 11. These steps are periodically repeated, preferably 55 to 85 times per one second.

On the other hand, in a conventional short circuit droplet transfer shown in FIG. 8B, the wire 4 is always fed only in a workpiece direction. A droplet 11 is formed by ignition of the arc and droplets 11 are allowed to undergo contact short circuit with a workpiece or molten pool, resulting in arc distinction. The droplet 11 subjected to contact short circuit is released form the wire 4 by an electromagnetic pinch force and a thermal pinch force.

In the method of a conventional short circuit droplet transfer as shown in FIG. 8B, it is difficult to optionally adjust the number of short circuits. Even when the aforementioned shielding gas is used, it has already been apparent from the test carried out by the present inventors that it is difficult to obtain beads, which can achieve a satisfactory level of bead-wettability and an amount of spatters by the method (see Test Example 1 of Table 5).

The reason why wettability of beads is not improved when a conventional short circuit droplet transfer is used is described below. When the aforementioned shielding gas is used, a proper arc length becomes shorter than that in the case of only an argon gas by a thermal pinch force produced. As a result, a proper arc voltage also becomes lower, resulting in a low heat input, thus fails to improve the wettability of beads. On the other hand, when the arc voltage is increased so as to increase heat input, the arc length increases and thus droplet transfer becomes unstable, resulting in a possibility of an increase in the occurrence of spatters, which is unfavorable.

To the contrary, in the form of short circuit droplet transfer according to the second and third aspects of the present invention, it is possible to optionally adjust the number of short circuits. Namely, since droplet transfer can be controlled without dependence on a pinch force, the generation of spatters can be reduced. By using the aforementioned shielding gas, beads which satisfy the required level of an amount of spatters and wettability can be obtained.

In the second and third aspects of the present invention, mechanical short circuit droplet transfer in the forward/backward moving operation of the wire 4 can be optionally selected. It is preferred that the short circuit droplet transfer is carried out 55 to 85 times per second. When the short circuit droplet transfer is carried out less than 55 times per second, the feed amount of the wire 4 is small and there is a possibility that the deposited amount required for stable formation of beads cannot be ensured. When the short circuit droplet transfer is carried out 85 times or more per second, since the time from arc ignition to formation of droplet, and contact and release of the wire to the workpiece becomes too short, there is a possibility that the wire is submerged into a molten pool in a state that droplets are insufficiently formed, and therefore, there is a possibility that spatters are likely to generate.

Control of the number of times of the short circuit droplet transfer can be carried out by selecting the number of times of the forward/backward moving operation of the wire 4 per second, or selecting the number of times of the forward/backward moving operation of the wire 4 with respect to the wire feed speed.

In the second and third aspects of the present invention, a welding current can be optionally selected, but is preferably set within a range of from 60 to 150 A. Therefore, when the value is smaller than the above range, the feed amount of the wire decreases and also the heat input amount decreases, and thus there is a possibility that the deposited amount required for stable formation of beads and sufficient wettability of beads cannot be ensured. When the value is more than the upper limit of the above range, since formation of droplets by arc ignition is likely to become insufficient, the wire is submerged into a molten pool, and thus spatters are likely to be generated.

In the second and third aspects of the present invention, in the case of carrying out joining of a joint in which sheet materials are laid one upon another, such as a lap joint or a joggled lap joint, in arc brazing of a zinc coated steel sheet, it is preferred that a heat input amount Q represented by the following equation (a) satisfies the following conditional expression (b) determined according to a sheet thickness of the material to be joined. When the heat input amount Q is smaller than the range of the expression (b), the wettability of beads is poor and there is a possibility that stable beads cannot be formed. When the value of the heat input amount Q is more than this range, since wire melting becomes excessive, an arc is likely to become unstable, and thus there is a possibility that spatters in the form of large particles are generated.

Q=(I×E×60)/v (a)

where
Q: Heat input amount (J/cm)
I: Average current (A)
E: Average arc voltage (V)
v: Brazing speed (cm/min)

625×t+125≦Q≦1,250×t+250 (b)

where t is a sheet thickness (mm) of steel sheet

The reason of limitation of a shielding gas composition according to the second and third aspects in the present invention will be described based on the consideration derived from the results of Test Examples described hereinafter.

When a given amount or more of an oxygen gas is added in an argon gas, a cathode spot of a base metal is stably formed and the concentricity of an arc increases. Therefore, an unstable arc phenomenon typified by meandering bead is improved.

The oxygen gas has a high potential gradient as compared with the argon gas. Therefore, under the condition of the same arc length, the arc voltage of the case, wherein an argon gas containing a predetermined amount of the oxygen gas is used, is high as compared with the case of using only the argon gas. Therefore, in the former case, the wettability of beads increases and flat beads are formed.

A helium gas has also high potential gradient as compared with the argon gas and enables an improvement of wettability of beads. However, the helium gas is unstable because of large spread of an arc, and therefore it is not preferred to use the helium alone. The helium gas can be preferably used by adding to the argon gas, together with the oxygen gas having an action of stabilizing by arc concentration.

On the other hand, when the oxygen gas is added in more than the required amount, an arc is excessively concentrated, resulting in poor stability (uniformity) of a bead width. Also, when oxidizability becomes excessive, slag is drastically generated, and there is a possibility that dusts are generated by peeling of coating. In this way, excess oxygen is unfavorable since peeling of coating may be caused.

When the helium gas is contained, like the third aspect, if the helium gas is added excessively, a droplet is not transferred by short circuit and droplets are continuously release from the wire, like spray transfer. Therefore, when a brazing speed is increased in this state, an arc becomes unstable and the bead width is likely to become non-uniform, and also spatters are likely to be generated, which is unfavorable. As the concentration of the helium gas added increases, the arc voltage also increases and a base metal is likely to be melted, and therefore, excessive addition is not preferred.

Since nitrogen is a causative of the generation of internal defects such as unstabilization of an arc and the generation of blow holes, the amount of nitrogen is preferably as small as possible. However, when the amount of nitrogen is 0.1% by volume or less, marked unstabilization of arc and internal defects do not arise.

As a result of various intensive studies so as to determine the conditions that satisfy the above requirements, it has been found that the minimum concentration of an oxygen gas in an argon gas is preferably 1.5% by volume and the concentration of the upper limit is preferably 7% by volume. It has also been found that, in the case that a helium gas is included in an argon gas,

the upper limit of the concentration of the helium gas is preferably 15% by volume.

### EXAMPLES

Test Examples of the present invention will be described below. However, the present invention is not limited to only these examples. In so far as there is no particular problem, modifications, additions and omissions of position, number, amount, kind and the like may be carried out.

Regarding tests shown in the following tables, it may be understood that Nos. 1 to 131 shown in Tables 1 to 4 correspond to Nos. A1 to A131 and Nos. 1 to 140 shown in Tables 5 to 9 correspond to Nos. B1 to B140, for the purpose of distinction.

### Test Example 1

### First Aspect

Using carbon steel sheets and stainless steel sheets each having a sheet thickness of 0.6 to 2.3 mm, welding of lap joint was carried out. After setting a gap between an upper sheet and a lower sheet to 0 mm, a forward angle of an arc torch to 5° and a slope angle to 30 degrees, arc brazing was carried out at a torch movement speed (brazing speed) of 1.0 to 3.0 m/min using a solid wire made of a copper-aluminum alloy. Stability of an arc (arc state) and a state of the generation of spatters were observed by a high-speed video camera. Also, the stability of a bead toe was evaluated by visual observation.

In Test Example 1, a welder capable of periodically carrying out pulse droplet transfer and mechanical short circuit droplet transfer, which is achieved by a forward/backward moving operation of a wire, was used as a welding source. A pulse current was applied 3 to 7 times per mechanical short circuit droplet transfer, which was provided by the forward/backward moving operation.

Using a mixed gas of an argon gas and an oxygen gas as a shielding gas, arc brazing was carried out. As shown in the tables, the composition of the oxygen gas was varied for comparison. Using an argon gas that is usually used in arc brazing, evaluation was also carried out for comparison.

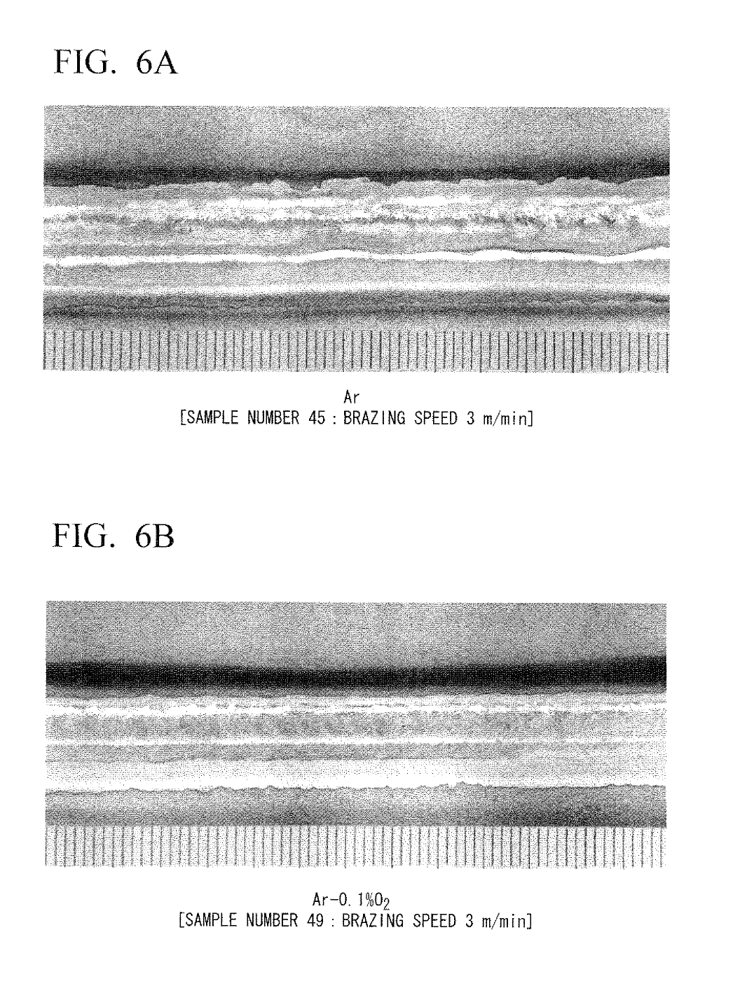

In FIG. 4, joint configuration and a target position of a torch in this Test Example are shown.

The test results are separately shown in Table 1 and Table 2.

### (Brazing Conditions)

A test was carried out under the following brazing conditions.

Brazing method: Consumable electrode type arc brazing
Base metal: Carbon steel sheet (SPCC), Stainless steel sheet (SUS430)
Sheet thickness: 0.6 to 2.3 mm
Joint shape: Lap joint
Wire: Copper aluminum alloy (aluminum bronze) solid wire CuAl8 (EN14640:2005), diameter: 1.0 mm
Gap between sheets: 0
Arc torch forward angle: 5°
Arc torch slope angle: 30°
Brazing speed: 1.0 to 3.0 m/min
Wire feed speed: 4.0 to 8.0 m/min
Shielding gas flow rate: 15 L/min
Average welding current: 70 to 150 A
Peak current Ip: 370 to 415 A
Base current Ib: 20 to 65 A
Pulse time Tp: 1.0 to 1.8 ms
Pulse fall time Tdown: 3.1 to 8.4 ms

(Evaluation)

The following three points as factors, that cause deterioration of glossy golden beads appearance and characteristically appear in case a copper-aluminum alloy wire is used, were evaluated. Regarding (i) spatters, (ii) bead irregularity and (iii) black discoloration (bead oxidation) due to surface oxidation of beads, the evaluation was carried out based on the following evaluation criteria.

### (i) Spatters

Samples, in which the generation of spatters accompanied by an unstable arc phenomenon are scarcely recognized, were rated “A” (Pass). Samples in which spatters do not adhere onto a surface of a base metal, although the generation of spatters is slightly recognized were rated “B” (Pass, although being inferior to A). Samples in which an arc becomes unstable and severe spatters are generated were rated “C” (Failure).

### (ii) Bead Irregularity

Samples in which uniform beads with a difference between a maximum value and a minimum value of a bead width being less than 2 mm are formed (excluding a start portion and a crater portion) were rated “A” (Pass). Samples in which a bead width varies little by little and uniformity of a bead width is slightly inferior, although the difference between a maximum value and a minimum value of a bead width is less than 2 mm were rated “B” (Pass, although being inferior to A). Samples in which bead irregularity with a difference between a maximum value and a minimum value of a bead width being 2 mm or more arises were rated “C” (Failure) (excluding a start portion and a crater portion).

(iii) (Bead Oxidation)

Samples in which neither discoloration nor wrinkles arise in beads were rated “A” (Pass). Samples in which wrinkles are not generated, although slight oxidation is recognized on a surface of beads were rated “B” (Pass, although being inferior to A). Samples, in which a surface of beads undergoes discoloration by oxidation and the generation of wrinkles are recognized, were rated “C” (Failure).

Regarding the evaluation results shown in Table 1 and Table 2, the test results in which the evaluation of each evaluation item includes only “A” and/or “B” are rated “Pass” in the comprehensive evaluation. In the case of the test rated “Pass”, “Inventive Example” are described in the remarks column in the table. Also, the test results in which one of more “C” exist in each evaluation item are rated “Failure” in the comprehensive evaluation. In the case of the test rated “Failure”, “Comparative Example” are described in the remarks column in the table.

TABLE 1

| | | | | | | | | Waveform | | | | |
|---|---|---|---|---|---|---|---|---|---|---|---|---|
| | Composition | | | Sheet assembly | | | | | | | | Number of |
| | of shielding | Brazing | | Upper | Lower | Wire feed | Wire feed | | | | | times of |
| | gas (% by | speed | | sheet | sheet | speed | amount | | | | Tdown | pulses |
| No. | volume) | (m/min) | Material | (mm) | (mm) | (m/min) | (g/m) | IP (A) | IB (A) | Tp (ms) | (ms) | (times/s) |
| 1 | Ar | 1.0 | SPCC | 0.7 | 0.7 | 4.0 | 23 | 370 | 20 | 1.8 | 8.4 | 3 |
| 2 | Ar—0.02% O₂ | | | | | | | | | | | |
| 3 | Ar—0.03% O₂ | | | | | | | | | | | |
| 4 | Ar—0.05% O₂ | | | | | | | | | | | |
| 5 | Ar—0.1% O₂ | | | | | | | | | | | |
| 6 | Ar—0.18% O₂ | | | | | | | | | | | |
| 7 | Ar—0.2% O₂ | | | | | | | | | | | |
| 8 | Ar—0.3% O₂ | | | | | | | | | | | |
| 9 | Ar—0.4% O₂ | | | | | | | | | | | |
| 10 | Ar—0.5% O₂ | | | | | | | | | | | |
| 11 | Ar—1% O₂ | | | | | | | | | | | |
| 12 | Ar | 1.5 | SUS430 | 2.0 | 2.0 | 7.0 | 27 | 380 | 60 | 1.0 | 3.1 | 7 |
| 13 | Ar—0.02% O₂ | | | | | | | | | | | |
| 14 | Ar—0.03% O₂ | | | | | | | | | | | |
| 15 | Ar—0.05% O₂ | | | | | | | | | | | |
| 16 | Ar—0.1% O₂ | | | | | | | | | | | |
| 17 | Ar—0.18% O₂ | | | | | | | | | | | |
| 18 | Ar—0.5% O₂ | | | | | | | | | | | |
| 19 | Ar | | SPCC | 2.3 | 2.3 | 8.0 | 31 | 415 | 65 | 1.3 | 3.1 | 7 |
| 20 | Ar—0.03% O₂ | | | | | | | | | | | |
| 21 | Ar—0.05% O₂ | | | | | | | | | | | |
| 22 | Ar—0.1% O₂ | | | | | | | | | | | |
| 23 | Ar—0.2% O₂ | | | | | | | | | | | |
| 24 | Ar—0.5% O₂ | | | | | | | | | | | |

| | Average | | | Evaluation of appearance | | | |
|---|---|---|---|---|---|---|---|
| | welding | Average arc | Heat input | | Bead | | |
| No. | current (A) | voltage (V) | (J/cm) | Spatters | irregularity | Bead oxidation | Remarks |
| 1 | 70 | 20.4 | 857 | C | C | A | Comparative Example |
| 2 | 70 | 19.6 | 823 | C | C | A | Comparative Example |
| 3 | 70 | 19.2 | 806 | B | B | A | Inventive Example |
| 4 | 70 | 18.8 | 790 | A | A | A | Inventive Example |
| 5 | 70 | 17.7 | 743 | A | A | A | Inventive Example |
| 6 | 70 | 17.1 | 718 | A | A | A | Inventive Example |
| 7 | 70 | 17.0 | 714 | B | A | A | Inventive Example |
| 8 | 70 | 16.5 | 693 | B | A | A | Inventive Example |
| 9 | 70 | 16.3 | 685 | C | A | A | Comparative Example |
| 10 | 70 | 16.2 | 680 | C | A | B | Comparative Example |
| 11 | 70 | 16.5 | 693 | C | A | C | Comparative Example |
| 12 | 130 | 22.9 | 1,191 | C | C | A | Comparative Example |
| 13 | 130 | 21.2 | 1,102 | C | B | A | Comparative Example |
| 14 | 130 | 21.0 | 1,092 | B | A | A | Inventive Example |
| 15 | 130 | 20.6 | 1,071 | A | A | A | Inventive Example |
| 16 | 130 | 20.0 | 1,040 | A | A | A | Inventive Example |
| 17 | 130 | 19.6 | 1,019 | A | A | A | Inventive Example |
| 18 | 130 | 19.6 | 1,019 | A | C | C | Comparative Example |
| 19 | 149 | 22.6 | 1,347 | C | C | A | Comparative Example |
| 20 | 149 | 21.8 | 1,299 | B | B | A | Inventive Example |
| 21 | 149 | 21.0 | 1,252 | A | A | A | Inventive Example |
| 22 | 149 | 20.7 | 1,234 | A | A | A | Inventive Example |
| 23 | 149 | 19.8 | 1,180 | B | A | B | Inventive Example |
| 24 | 149 | 19.4 | 1,156 | C | C | C | Comparative Example |

TABLE 2

| | | | | | | | | Waveform | | | | |
|---|---|---|---|---|---|---|---|---|---|---|---|---|
| | Composition | | | Sheet assembly | | | | | | | | Number of |
| | of shielding | Brazing | | Upper | Lower | Wire feed | Wire feed | | | | | times of |
| | gas (% by | speed | | sheet | sheet | speed | amount | | | | Tdown | pulses |
| No. | volume) | (m/min) | Material | (mm) | (mm) | (m/min) | (g/m) | IP (A) | IB (A) | Tp (ms) | (ms) | (times/s) |
| 25 | Ar | 2.0 | SPCC | 0.7 | 0.7 | 6.5 | 19 | 405 | 40 | 1.8 | 5.3 | 4 |
| 26 | Ar—0.02% O₂ | | | | | | | | | | | |
| 27 | Ar—0.03% O₂ | | | | | | | | | | | |
| 28 | Ar—0.05% O₂ | | | | | | | | | | | |
| 29 | Ar—0.1% O₂ | | | | | | | | | | | |
| 30 | Ar—0.18% O₂ | | | | | | | | | | | |
| 31 | Ar—0.2% O₂ | | | | | | | | | | | |
| 32 | Ar—0.3% O₂ | | | | | | | | | | | |
| 33 | Ar—0.4% O₂ | | | | | | | | | | | |
| 34 | Ar—0.5% O₂ | | | | | | | | | | | |
| 35 | Ar | 2.5 | SPCC | 1.0 | 1.0 | 8.0 | 19 | 415 | 65 | 1.3 | 3.1 | 7 |
| 36 | Ar—0.02% O₂ | | | | | | | | | | | |
| 37 | Ar—0.03% O₂ | | | | | | | | | | | |
| 38 | Ar—0.05% O₂ | | | | | | | | | | | |
| 39 | Ar—0.1% O₂ | | | | | | | | | | | |
| 40 | Ar—0.18% O₂ | | | | | | | | | | | |
| 41 | Ar—0.2% O₂ | | | | | | | | | | | |
| 42 | Ar—0.3% O₂ | | | | | | | | | | | |
| 43 | Ar—0.4% O₂ | | | | | | | | | | | |
| 44 | Ar—0.5% O₂ | | | | | | | | | | | |
| 45 | Ar | 3.0 | SPCC | 0.6 | 0.6 | 7.0 | 14 | 400 | 45 | 1.3 | 4.5 | 6 |
| 46 | Ar—0.02% O₂ | | | | | | | | | | | |
| 47 | Ar—0.03% O₂ | | | | | | | | | | | |
| 48 | Ar—0.05% O₂ | | | | | | | | | | | |
| 49 | Ar—0.1% O₂ | | | | | | | | | | | |
| 50 | Ar—0.18% O₂ | | | | | | | | | | | |
| 51 | Ar—0.2% O₂ | | | | | | | | | | | |
| 52 | Ar—0.3% O₂ | | | | | | | | | | | |
| 53 | Ar—0.4% O₂ | | | | | | | | | | | |

| | Average | | | Evaluation of appearance | | | |
|---|---|---|---|---|---|---|---|
| | welding | Average arc | Heat input | | Bead | | |
| No. | current (A) | voltage (V) | (J/cm) | Spatters | irregularity | Bead oxidation | Remarks |
| 25 | 121 | 21.7 | 788 | B | C | A | Comparative Example |
| 26 | 121 | 21.5 | 780 | B | C | A | Comparative Example |
| 27 | 121 | 20.9 | 759 | B | B | A | Inventive Example |
| 28 | 121 | 20.5 | 744 | A | A | A | Inventive Example |
| 29 | 121 | 19.1 | 693 | A | A | A | Inventive Example |
| 30 | 121 | 18.8 | 682 | A | A | A | Inventive Example |
| 31 | 121 | 18.6 | 675 | A | A | B | Inventive Example |
| 32 | 121 | 18.9 | 686 | B | A | B | Inventive Example |
| 33 | 121 | 19.0 | 690 | C | B | B | Comparative Example |
| 34 | 121 | 19.0 | 690 | C | C | C | Comparative Example |
| 35 | 150 | 22.0 | 792 | B | C | A | Comparative Example |
| 36 | 150 | 21.5 | 774 | B | C | A | Comparative Example |
| 37 | 150 | 22.3 | 803 | A | B | A | Inventive Example |
| 38 | 150 | 21.3 | 767 | A | A | A | Inventive Example |
| 39 | 150 | 20.8 | 749 | A | A | A | Inventive Example |
| 40 | 150 | 20.3 | 731 | A | A | A | Inventive Example |
| 41 | 150 | 20.1 | 724 | B | A | A | Inventive Example |
| 42 | 150 | 20.0 | 720 | B | A | B | Inventive Example |
| 43 | 150 | 19.9 | 716 | C | A | B | Comparative Example |
| 44 | 150 | 19.9 | 716 | C | C | C | Comparative Example |
| 45 | 128 | 21.9 | 561 | A | C | A | Comparative Example |
| 46 | 128 | 21.1 | 540 | A | C | A | Comparative Example |
| 47 | 128 | 20.8 | 532 | A | B | A | Inventive Example |
| 48 | 128 | 20.2 | 517 | A | A | A | Inventive Example |
| 49 | 128 | 19.7 | 504 | A | A | A | Inventive Example |
| 50 | 128 | 19.4 | 497 | A | A | A | Inventive Example |
| 51 | 128 | 19.3 | 494 | B | A | A | Inventive Example |
| 52 | 128 | 19.0 | 486 | B | B | A | Inventive Example |
| 53 | 128 | 19.2 | 492 | C | C | B | Comparative Example |

As is apparent from the results shown in Table 1 and Table 2, in the test (a brazing speed is from 1.0 to 3.0 m/min and a pulse fall time Tdown is from 3.1 to 8.4 ms) carried out, satisfactory results were obtained by using a mixed gas consisting of an oxygen gas having a concentration adjusted within a range of from 0.03 to 0.3% by volume with the remainder including argon.

It has also been found that more satisfactory results (all “A” in the evaluation) can be obtained by using a mixed gas wherein the concentration of the oxygen gas is adjusted within a range of from 0.05 to 0.18% by volume.

### Test Example 2

### First Aspect

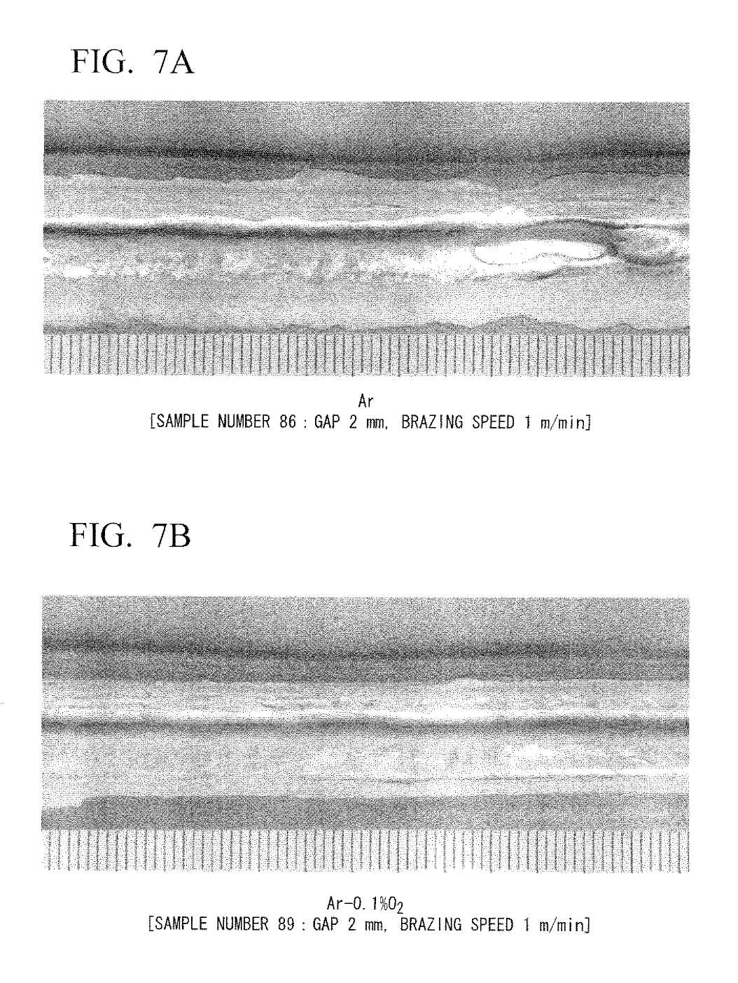

Using two carbon steel sheets each having a sheet thickness of 0.6 to 1.0 mm, welding of lap joint was carried out. A gap between carbon steel sheets, i.e. a gap between an upper sheet and a lower sheet was set to be within a range of from 0 to 2.0 mm. A target position of a wire was set to be within a range between the point that is 2 mm apart from the intersection point toward the lower sheet side (hereinafter referred to a target position − side), and the point that is 3 mm apart from the intersection point toward the upper sheet side (hereinafter referred to a target position + side). The range extends from side to side from the intersection point, and the intersection point (hereinafter referred to a target position 0) exists between the perpendicular drawn from a sheet end of a sheet material, which is located on the uppermost side of carbon sheets laid one upon another, and a top surface of a sheet material located on the lowermost side. After setting the forward angle of an arc torch to 5° and a slope angle to 30 degrees, arc brazing was carried out at a brazing speed of 0.8 to 1.5 m/min using a solid wire made of a copper-aluminum alloy. Stability of an arc and a situation of the generation of spatters were observed by a high-speed video camera, and no gap bridging, burn through and the generation of bead irregularity were visually observed based on the difference of a gap amount and a wire target position. In FIG. 5, the joint configuration and the target position of a torch of this example are shown.

As the welding source, the same welder as in Test Example 1 was used. A pulse current was applied 4 times and 8 times per mechanical short circuit droplet transfer by a forward/backward moving operation of a wire. Using a mixed gas of an argon gas and an oxygen gas as a shielding gas, arc brazing was carried out. As shown in the tables, the ratio of an oxygen gas included in an argon gas was varied for comparison.

In Table 3, the test results at the target position 0 are shown. In Table 4, the test results were obtained by carrying out arc brazing under the same brazing condition as in Table 3, except that the target position was changed in a range from 2 mm, which is apart from the intersection point toward − side, to 3 mm, which is apart from the intersection point toward + side. It may be understood that samples 54 to 131 shown in Tables 3 to 4 correspond to samples A54 to R131, in order to distinguishing the samples from samples shown in the another tables.

### (Brazing Conditions)

Brazing method: Consumable electrode type arc brazing
Base metal: carbon steel sheet (SPCC), sheet thickness: 0.6 to 1.0 mm
Joint shape: Lap joint
Wire: Copper aluminum alloy (aluminum bronze) solid wire CuAl8 (EN14640:2005), diameter: 1.0 mm
Brazing speed: 0.8 to 1.5 m/min
Gap between sheets: 0 to 2.0 mm
Arc torch forward angle: 5°
Arc torch slope angle: 30°
Brazing speed: 0.8 to 1.5 m/min
Wire feed speed: 5.5 to 7.0 m/min
Shielding gas flow rate: 15 L/min
Average welding current: 100 to 130 A
Peak current Ip: 370 to 390 A
Base current Ib: 30 to 50 A
Pulse time Tp: 1.0 to 1.7 ms
Pulse fall time Tdown: 3.7 to 6.9 ms

(Evaluation)

The evaluation was carried out with respect to the following three points, i.e. (i) spatters, (ii) bead irregularity such as burn through and no gap bridging, which are factors that cause deterioration of joint quality of a lap joint, and (iii) black discoloration due to a surface oxidation of beads, which is a factor that cause deterioration of the appearance of glossy golden beads wherein the appearance characteristically appears in case a copper-aluminum alloy wire is used. The evaluation of them was carried out based on the following evaluation criteria.

### (Evaluation of Table 3)

### (i) Spatters

Samples in which the generation of spatters, which is caused due to an unstable arc phenomenon, is scarcely recognized were rated “A” (Pass). Samples in which spatters do not adhere onto a surface of a base metal, although the generation of spatters is slightly recognized were rated “B” (Pass, although being inferior to A). Samples in which an arc becomes unstable and severe spatters are generated were rated “C” (Failure).

(ii) Bead irregularity

Samples, in which bead irregularity caused by an unstable arc phenomenon is not recognized, and in which neither burn through nor no gap bridging occurs in beads, were rated “A” (Pass). Samples in which an arc becomes unstable and severe bead irregularity occurs, and samples in which burn through and no gap bridging arise in beads were rated “C” (Failure).

(iii) Black Discoloration (Beads Oxidation)

Samples in which neither discoloration nor wrinkling of beads occurs were rated “A” (Pass). Samples in which wrinkles were not generated, although slight oxidation is recognized on a surface of beads, were rated “B” (Pass, although being inferior to A). Samples in which a surface of beads undergoes discoloration by oxidation and the generation of wrinkles is recognized were rated “C”

### (Failure)

Regarding the evaluation results shown in Table 3, the test results in which the evaluation of each evaluation item includes only “A” and/or “B” were rated “Pass” in the comprehensive evaluation. In the case of the test rated “Pass”, “Inventive Example” was described in the remarks column in the table. Also, the test results in which one of more “C” exist in each evaluation item were rated “Failure” in the comprehensive evaluation. In the case of the test rated “Failure”, “Comparative Example” was described in the remarks column in the table.

### (Evaluation of Table 4)

In the test in which the target position was varied in a range from 2 mm (− side from the intersection point) to 3 mm (+ side from the intersection point), the generation of no gap bridging and burn through were evaluated according to the condition that a wire target position and a gap amount were changed. The results evaluated shown below are shown in Table 4.

“A” Pass: Neither no gap bridging nor burn through generated.
“C” (Failure): no gap bridging and burn through generated.

In the evaluation results shown in Table 4, the test results in which the evaluation of three evaluation item includes only “A” and/or “B” and also the evaluation is “A” even when a target position of a wire is within a range of from −1 to +2 mm are rated “Pass” in the comprehensive evaluation. In the case of the test rated “Pass”, “Inventive Example” are described in the remarks column in the table. Also, the test results samples that do not meet the above conditions are rated “Failure”, and “Comparative Example” are described in the remarks column in the table.

TABLE 3

| | | | | | | | | Waveform | | | | |
|---|---|---|---|---|---|---|---|---|---|---|---|---|
| | Composition | Sheet assembly | | | | | | | | | | Number of |
| | of shielding | Upper | Lower | | Brazing | Wire feed | Wire feed | | | | | times of |
| | gas (% by | sheet | sheet | Gap | speed | speed | amount | | | | Tdown | pulses |
| No. | volume) | (mm) | (mm) | (mm) | (m/min) | (m/min) | (g/m) | IP (A) | IB (A) | Tp (ms) | (ms) | (times/s) |
| 54 | Ar | 0.7 | 0.7 | 0 | 1.0 | 5.5 | 32 | 370 | 30 | 1.7 | 6.9 | 4 |
| 55 | Ar—0.03% O₂ | | | | | | | | | | | |
| 56 | Ar—0.05% O₂ | | | | | | | | | | | |
| 57 | Ar—0.1% O₂ | | | | | | | | | | | |
| 58 | Ar—0.18% O₂ | | | | | | | | | | | |
| 59 | Ar—0.3% O₂ | | | | | | | | | | | |
| 60 | Ar—0.5% O₂ | | | | | | | | | | | |
| 61 | Ar | 0.6 | 0.6 | 0.6 | 1.5 | 5.5 | 21 | 370 | 30 | 1.7 | 6.9 | 4 |
| 62 | Ar—0.03% O₂ | | | | | | | | | | | |
| 63 | Ar—0.05% O₂ | | | | | | | | | | | |
| 64 | Ar—0.1% O₂ | | | | | | | | | | | |
| 65 | Ar—0.18% O₂ | | | | | | | | | | | |
| 66 | Ar—0.3% O₂ | | | | | | | | | | | |
| 67 | Ar—0.5% O₂ | | | | | | | | | | | |
| 68 | Ar | 1.0 | 0.7 | 1.0 | 1.2 | 6.0 | 29 | 370 | 40 | 1.6 | 5.4 | 4 |
| 69 | Ar—0.03% O₂ | | | | | | | | | | | |
| 70 | Ar—0.05% O₂ | | | | | | | | | | | |
| 71 | Ar—0.1% O₂ | | | | | | | | | | | |
| 72 | Ar—0.18% O₂ | | | | | | | | | | | |
| 73 | Ar—0.3% O₂ | | | | | | | | | | | |
| 74 | Ar—0.5% O₂ | | | | | | | | | | | |
| 75 | Ar | 0.7 | 0.7 | 1.4 | 1.0 | 5.5 | 32 | 370 | 30 | 1.7 | 6.9 | 4 |
| 76 | Ar—0.03% O₂ | | | | | | | | | | | |
| 77 | Ar—0.07% O₂ | | | | | | | | | | | |
| 78 | Ar—0.1% O₂ | | | | | | | | | | | |
| 79 | Ar—0.18% O₂ | | | | | | | | | | | |
| 80 | Ar—0.3% O₂ | | | | | | | | | | | |
| 81 | Ar | 1.0 | 1.0 | 1.6 | 0.8 | 5.5 | 40 | 370 | 30 | 1.7 | 6.9 | 4 |
| 82 | Ar—0.05% O₂ | | | | | | | | | | | |
| 83 | Ar—0.1% O₂ | | | | | | | | | | | |
| 84 | Ar—0.15% O₂ | | | | | | | | | | | |
| 85 | Ar—0.3% O₂ | | | | | | | | | | | |
| 86 | Ar | 1.0 | 1.0 | 2.0 | 1.0 | 7.0 | 41 | 390 | 50 | 1.0 | 3.7 | 8 |
| 87 | Ar—0.03% O₂ | | | | | | | | | | | |
| 88 | Ar—0.05% O₂ | | | | | | | | | | | |
| 89 | Ar—0.1% O₂ | | | | | | | | | | | |
| 90 | Ar—0.18% O₂ | | | | | | | | | | | |
| 91 | Ar—0.3% O₂ | | | | | | | | | | | |
| 92 | Ar—0.4% O₂ | | | | | | | | | | | |

| | | | | | Evaluation of appearance | | | |
|---|---|---|---|---|---|---|---|---|
| | Target | Average welding | Average arc | Heat input | | Bead | Bead | |
| No. | position | current (A) | voltage (V) | (J/cm) | Spatters | irregularity | oxidation | Remarks |
| 54 | 0 | 100 | 22.0 | 1320 | C | C | A | Comparative Example |
| 55 | 0 | 100 | 21.0 | 1260 | A | A | A | Inventive Example |
| 56 | 0 | 100 | 20.5 | 1230 | A | A | A | Inventive Example |
| 57 | 0 | 100 | 19.5 | 1170 | A | A | A | Inventive Example |
| 58 | 0 | 100 | 18.6 | 1116 | A | A | A | Inventive Example |
| 59 | 0 | 100 | 18.0 | 1080 | B | A | B | Inventive Example |
| 60 | 0 | 100 | 18.3 | 1098 | C | A | C | Comparative Example |
| 61 | 0 | — | — | — | C | C, Burn | A | Comparative Example |
| | | | | | | through | | |
| 62 | 0 | 100 | 21.0 | 840 | B | A | A | Inventive Example |
| 63 | 0 | 100 | 20.6 | 824 | A | A | A | Inventive Example |
| 64 | 0 | 100 | 19.6 | 784 | A | A | A | Inventive Example |
| 65 | 0 | 100 | 18.8 | 752 | A | A | A | Inventive Example |
| 66 | 0 | 100 | 18.4 | 736 | B | A | B | Inventive Example |
| 67 | 0 | 100 | 18.1 | 724 | C | A | C | Comparative Example |
| 68 | 0 | 113 | 22.3 | 1260 | C | A | A | Comparative Example |
| 69 | 0 | 113 | 21.9 | 1237 | B | A | A | Inventive Example |
| 70 | 0 | 113 | 21.4 | 1209 | A | A | A | Inventive Example |
| 71 | 0 | 113 | 20.4 | 1153 | A | A | A | Inventive Example |
| 72 | 0 | 113 | 19.2 | 1085 | A | A | A | Inventive Example |
| 73 | 0 | 113 | 18.9 | 1068 | B | A | B | Inventive Example |
| 74 | 0 | 113 | 18.8 | 1062 | B | A | C | Comparative Example |
| 75 | 0 | — | — | — | C | C, Burn | A | Comparative Example |
| | | | | | | through | | |
| 76 | 0 | 100 | 21.5 | 1290 | B | A | A | Inventive Example |
| 77 | 0 | 100 | 21.1 | 1266 | A | A | A | Inventive Example |
| 78 | 0 | 100 | 20.4 | 1224 | A | A | A | Inventive Example |
| 79 | 0 | 100 | 19.4 | 1164 | A | A | A | Inventive Example |
| 80 | 0 | 100 | 18.9 | 1134 | A | A | B | Inventive Example |
| 81 | 0 | 100 | 22.1 | 1658 | C | C | A | Comparative Example |
| 82 | 0 | 100 | 20.9 | 1568 | A | A | A | Inventive Example |
| 83 | 0 | 100 | 19.9 | 1493 | A | A | A | Inventive Example |
| 84 | 0 | 100 | 19.3 | 1448 | A | A | A | Inventive Example |
| 85 | 0 | 100 | 18.5 | 1388 | B | A | B | Inventive Example |
| 86 | 0 | 130 | 23.4 | 1825 | C | C | A | Comparative Example |
| 87 | 0 | 130 | 23.0 | 1794 | A | A | A | Inventive Example |
| 88 | 0 | 130 | 22.6 | 1763 | A | A | A | Inventive Example |
| 89 | 0 | 130 | 22.1 | 1724 | A | A | A | Inventive Example |
| 90 | 0 | 130 | 21.0 | 1638 | A | A | A | Inventive Example |
| 91 | 0 | 130 | 20.7 | 1615 | B | A | B | Inventive Example |
| 92 | 0 | 130 | 20.5 | 1599 | B | A | C | Comparative Example |

TABLE 4

| | Composition | Sheet assembly | | | | Wire | | | | | | | |
|---|---|---|---|---|---|---|---|---|---|---|---|---|---|
| | of shielding | Upper | Lower | | Brazing | feed | | | | | | | |
| | gas (% by | sheet | sheet | Gap | speed | amount | Target position (mm) | | | | | | |
| No. | volume) | (mm) | (m) | (mm) | (m/min) | (g/m) | −2 | −1 | 0 | +1 | +2 | +3 | Remarks |
| 93 | Ar | 0.7 | 0.7 | 0 | 10 | 32 | C | A | A | A | C | C | Comparative Example |
| 94 | Ar—0.03% O₂ | | | | | | C | A | A | A | A | C | Inventive Example |
| 95 | Ar—0.05% O₂ | | | | | | C | A | A | A | A | C | Inventive Example |
| 96 | Ar—0.1% O₂ | | | | | | C | A | A | A | A | C | Inventive Example |
| 97 | Ar—0.18% O₂ | | | | | | C | A | A | A | A | C | Inventive Example |
| 98 | Ar—0.3% O₂ | | | | | | C | A | A | A | A | C | Inventive Example |
| 99 | Ar—0.5% O₂ | | | | | | C | A | A | A | A | C | Comparative Example |
| 100 | Ar | 0.6 | 0.6 | 0.6 | 1.5 | 21 | — | C | C | A | C | — | Comparative Example |
| 101 | Ar—0.03% O₂ | | | | | | C | A | A | A | A | C | Inventive Example |
| 102 | Ar—0.05% O₂ | | | | | | C | A | A | A | A | C | Inventive Example |
| 103 | Ar—0.1% O₂ | | | | | | C | A | A | A | A | C | Inventive Example |
| 104 | Ar—0.18% O₂ | | | | | | C | A | A | A | A | C | Inventive Example |
| 105 | Ar—0.3% O₂ | | | | | | C | A | A | A | A | C | Inventive Example |
| 106 | Ar—0.5% O₂ | | | | | | C | A | A | A | A | C | Comparative Example |
| 107 | Ar | 1.0 | 0.7 | 1.0 | 1.2 | 29 | C | C | A | A | C | C | Comparative Example |
| 108 | Ar—0.03% O₂ | | | | | | C | A | A | A | A | C | Inventive Example |
| 109 | Ar—0.05% O₂ | | | | | | C | A | A | A | A | C | Inventive Example |
| 110 | Ar—0.1% O₂ | | | | | | C | A | A | A | A | C | Inventive Example |
| 111 | Ar—0.18% O₂ | | | | | | C | A | A | A | A | C | Inventive Example |
| 112 | Ar—0.3% O₂ | | | | | | C | A | A | A | A | C | Inventive Example |
| 113 | Ar—0.5% O₂ | | | | | | C | A | A | A | C | C | Comparative Example |
| 114 | Ar | 0.7 | 0.7 | 1.4 | 1.0 | 32 | C | C | C | C | C | C | Comparative Example |
| 115 | Ar—0.03% O₂ | | | | | | C | A | A | A | A | C | Inventive Example |
| 116 | Ar—0.07% O₂ | | | | | | C | A | A | A | A | C | Inventive Example |
| 117 | Ar—0.1% O₂ | | | | | | C | A | A | A | A | C | Inventive Example |
| 118 | Ar—0.18% O₂ | | | | | | C | A | A | A | A | C | Inventive Example |
| 119 | Ar—0.3% O₂ | | | | | | C | A | A | A | A | C | Inventive Example |
| 120 | Ar | 1.0 | 1.0 | 1.6 | 0.8 | 40 | C | A | A | C | C | C | Comparative Example |
| 121 | Ar—0.05% O₂ | | | | | | C | A | A | A | A | A | Inventive Example |
| 122 | Ar—0.1% O₂ | | | | | | C | A | A | A | A | A | Inventive Example |
| 123 | Ar—0.15% O₂ | | | | | | C | A | A | A | A | A | Inventive Example |
| 124 | Ar—0.03% O₂ | | | | | | C | A | A | A | A | C | Inventive Example |
| 125 | Ar | 1.0 | 1.0 | 2.0 | 1.0 | 41 | C | C | C | C | C | C | Comparative Example |
| 126 | Ar—0.03% O₂ | | | | | | C | A | A | A | A | C | Inventive Example |
| 127 | Ar—0.05% O₂ | | | | | | C | A | A | A | A | C | Inventive Example |
| 128 | Ar—0.1% O₂ | | | | | | C | A | A | A | A | C | Inventive Example |
| 129 | Ar—0.18% O₂ | | | | | | C | A | A | A | A | C | Inventive Example |
| 130 | Ar—0.3% O₂ | | | | | | C | A | A | A | A | C | Inventive Example |
| 131 | Ar—0.4% O₂ | | | | | | C | A | A | A | A | C | Comparative Example |

As is apparent from the results shown in Table 3 and Table 4, in the test carried out (arc brazing of a thin sheet having a sheet thickness of 0.6 to 1.0 mm, the brazing speed is from 0.8 to 1.5 m/min, the gap between sheets is from 0 to 2.0 mm, the target position of a wire is evaluated by moving from the intersection point from side to side), by using a mixed gas consisting of an oxygen gas having a concentration adjusted to be within a range from 0.03 to 0.3% by volume with the remainder which is an argon gas, it is possible to obtain satisfactory results in which the generation of spatters and bead irregularity is reduced, and neither burn through nor no gap bridging occurs, even when there is a gap or target missing is occurred.

It has also been found that more satisfactory results (all “A” in the evaluation) can be obtained by adjusting the concentration of the oxygen gas to be within a range of from 0.05 to 0.18% by volume.

Particularly, when a gap is present (0.6 to 2.0 mm in a test) between sheets, a conventional gas is likely to cause burn through and no gap bridging after welding. When the gap between sheets is within a range of from one to two times the sheet thickness of the lower sheet located on the lowermost side of the joint, burn through and no gap bridging occurs in most target positions. To the contrary, when a shielding gas of the present invention is used, it is possible to join sheets even when a gap becomes large.

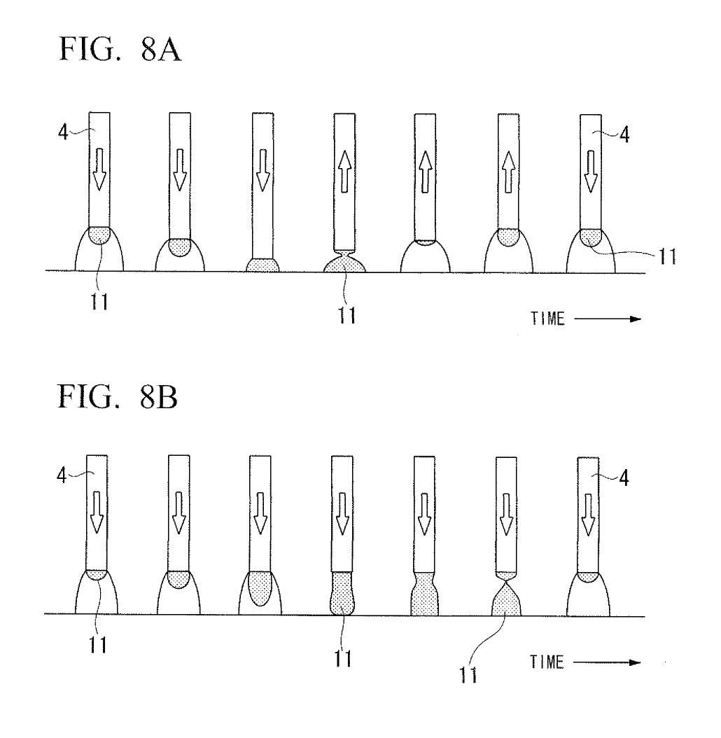

FIG. 6A and FIG. 65 are photographs each showing the appearance of beads of a sample No. 45 (Comparative Example) and a sample No. 49 (product of the present invention) in Table 1. In the photograph of the sample No. 45, beads non-uniformly undulate.

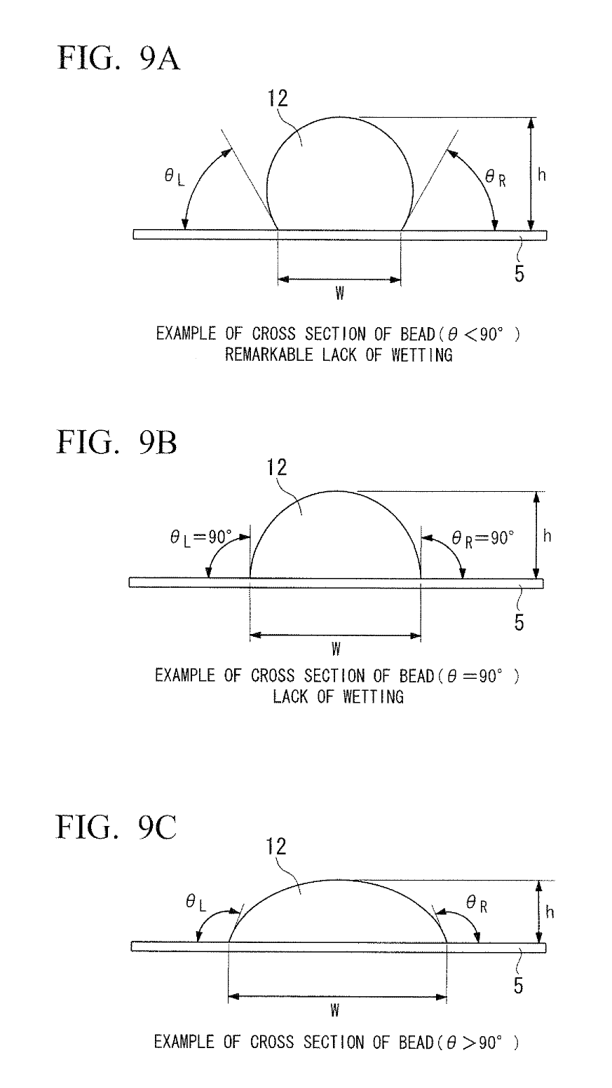

FIG. 7A and FIG. 7B are photographs each showing the appearance of beads of a sample No. 86 (Comparative Example) and a sample No. 89 (product of the present invention) in Table 2. In the photograph of the sample No. 86, burn through occurs.

As described above, it could be confirmed that excellent effects can be obtained in the first aspect of the present invention.

### Test Example 3

### Second Aspect

In a hot-dip alloyed zinc-coated steel sheet having a sheet thickness of 1.4 mm, arc brazing was carried out at a brazing speed of 0.6 m/min in a posture of holding an arc torch perpendicularly to a sheet material. Furthermore, arc brazing was carried out under the same conditions using a test body of the same lot and spatters that were generated were collected by a sampling box made of copper.

Using two welders as a welding source, a difference in a spatter generation amount and the wettability of beads, which is caused by a difference in steps in droplet transfer shown in FIGS. 8A and 8B, was evaluated. As two welders, a conventional type consumable electrode type arc welder in which a wire utilized commonly in arc brazing is always fed in a workpiece direction (hereinafter abbreviated to a welder 1) and a welder in which mechanical short circuit droplet transfer is periodically carried out by a forward/backward moving operation of a wire respective to a workpiece (hereinafter abbreviated to a welder 2) were used.

Using mixed gases of an argon gas and an oxygen gas as a shielding gas, arc brazing was carried out such that the ratio of an oxygen gas in the mixed gases was varied. Furthermore, for comparison, an argon gas used usually in arc brazing was used.

(Brazing Conditions)

A test was carried out under the following brazing conditions.

Brazing method: Consumable electrode type short arc (short circuit arc)
Base metal: Hot-dip alloyed zinc-coated steel sheet, sheet thickness: 1.4 mm
Joint shape: Bead-on-plate
Wire: Copper-silicon alloy (silicon bronze) solid wire CuSi3Mn1 (EN14640:2005), diameter: 1.0 mm
Arc torch posture: Vertically downwards
Brazing speed: 0.6 m/min
Shielding gas flow rate: 15 L/min
Wire protrusion length: 12 mm

### Welder 1

Wire feed speed: 6.2 m/min

Average welding current: 106 to 125 A

### Welder 2

Wire feed speed: 6.0 to 6.9 m/min

Average welding current: 92 to 93 A

Average number of short circuits: 75 times/seconds

### (Evaluation)

The evaluation was carried out with respect to the following five points. With respect to factors (i) the stability of arc, (ii) the stability of beads, (iii) the slag production amount and the peeling state due to oxidation of molten metal, (iv) the wettability of beads and (v) the sputter collection amount (g/min) as factors that cause deterioration of joint performances of arc brazing, the evaluation was carried out by the following method.

### Stability of Arc

The situation of the generation of unstable behavior associated with excessive spread of an arc was observed by a high-speed video camera. Samples in which an arc is stable were rated “A” (Pass), samples in which an arc is slightly unstable were rated “B” (Pass, although being inferior to A), and samples in which an arc is unstable were rated “C” (Failure).

### Stability of Beads

By visual observation, samples in which beads are formed in a uniform bead width were rated “A” (Pass), samples in which disorder arises in a bead width were rated “B” (Pass, although being inferior to A), and samples in which a severe change arises in a bead width and a bead height by meandering beads and humping of beads were rated “C” (Failure).

### Production Amount of Slag and Peeling State of Beads

By visual observation, samples in which the formation of a slag is not recognized were rated “A” (Pass), samples in which the formation of a slag is slightly recognized but the slag is not easily peeled were rated “B” (Pass, although being inferior to A) and samples in which the formation and peeling of a slag are remarkably recognized were rated “C” (Failure).

### Wettability of Beads

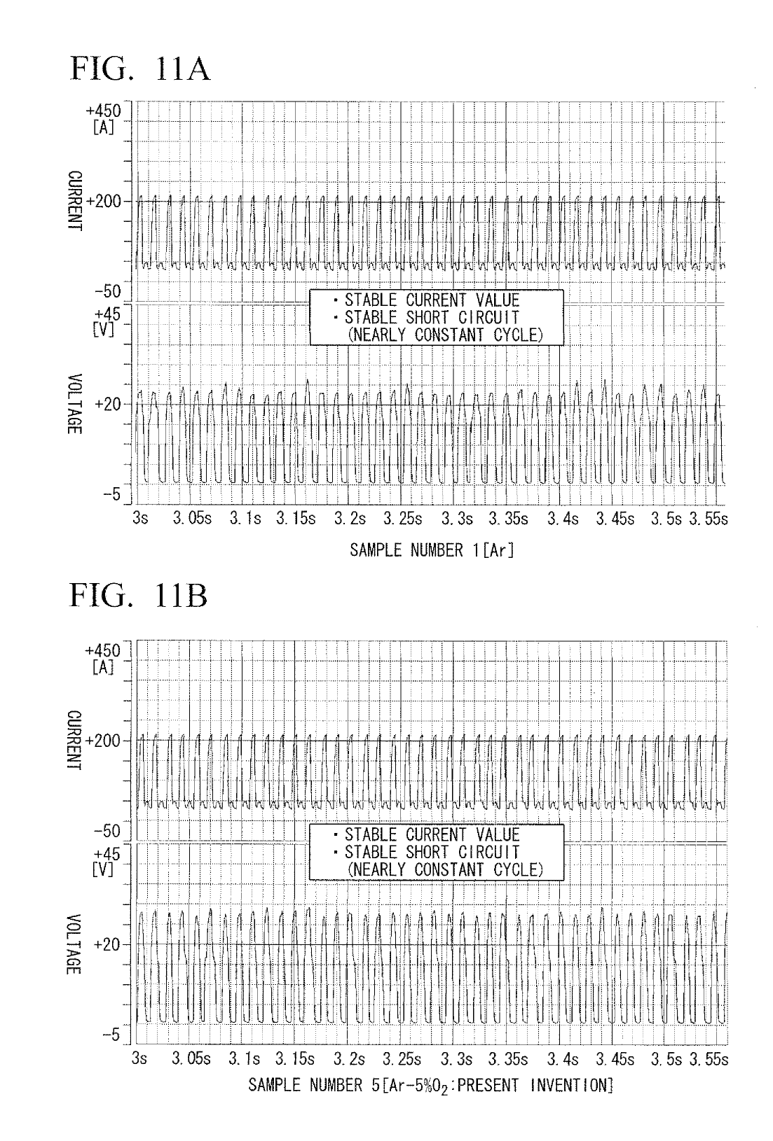

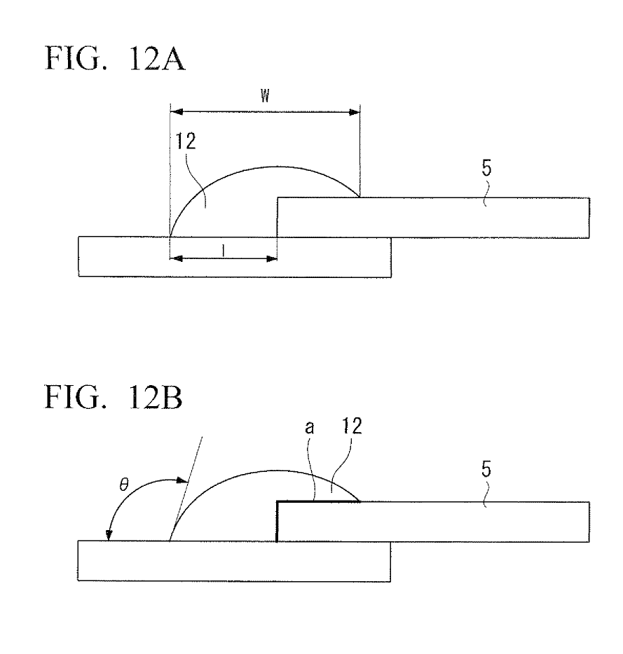

By cross-section observation, the width w, the height h and the wetting angle of beads 12 shown in FIG. 9A to FIG. 9C were measured and the degree of affinity with a base metal 5 was evaluated.

In the evaluation, samples in which a (w/h) value obtained by dividing a bead width w by a bead height h is 2.5 or more and also both wetting angles (θ_{L}, θ_{R}) of right and left of beads are 110° or more were judged to have satisfactory wettability and rated “A” (Pass). Samples in which a w/h value is 2.5 or more and also both θ_{L} and θ_{R} are 100° or more and less than 110° were rated “B” (Pass, although being inferior to A). Samples in which a w/h value and both θ_{L} and θ_{R} are not within the above range were rated “C” (Failure).

### Sputter Generation Amount

Samples in which a sputter generation amount is less than 0.5 g/min were rated “A” (Pass), samples in which a sputter generation amount is 0.5 g/min or more and less than 1.0 g/min were rated “B” (Pass, although being inferior to A) and samples in which a sputter generation amount is 1.0 g/min or more were rated “C” (Failure).

Samples rated “A” (Pass) or “B” (Pass, although being inferior to A) in all evaluation items were rated “Pass”, and “Present Inventive Example” was described in the remarks column in Table 5. Also, samples that do not meet the above conditions were rated “Failure”, and “Comparative Example” was described in the remarks column in the table.

TABLE 5

| | Composition | | | Wire | | Average | | Sputter | | |
|---|---|---|---|---|---|---|---|---|---|---|
| | of shielding | Brazing | Droplet | feed | Average | arc | Heat input | generation | Bead | Bead |
| Test | gas (% by | speed: v | transfer | speed | current: I | voltage: E | amount: Q | amount | width: w | height: h |
| No. | volume) | (m/min) | form | (m/min) | (A) | (V) | (J/cm) | (g/min) | (mm) | (mm) |
| 1 | Ar | 0.6 | FIG. 8A | 6.7 | 92 | 11.8 | 1086 | 0.015 | 2.7 | 2.5 |
| 2 | Ar—1% O₂ | | | 6.9 | 92 | 11.9 | 1095 | 0.004 | 4.6 | 2.4 |
| 3 | Ar—2% O₂ | | | 6.6 | 92 | 12.4 | 1141 | 0.004 | 6.0 | 1.9 |
| 4 | Ar—3% O₂ | | | 6.3 | 92 | 12.3 | 1132 | 0.004 | 7.2 | 1.6 |
| 5 | Ar—5% O₂ | | | 6.2 | 93 | 12.4 | 1153 | 0.015 | 7.5 | 1.5 |
| 6 | Ar—7% O₂ | | | 6.1 | 93 | 12.7 | 1181 | 0.022 | 7.7 | 1.6 |
| 7 | Ar—9% O₂ | | | 6.0 | 93 | 13.1 | 1218 | 0.024 | 6.8 | 1.6 |
| 8 | Ar—10% O₂ | | | 6.0 | 93 | 13.1 | 1218 | 0.035 | 6.8 | 1.6 |
| 9 | Ar | 0.6 | FIG. 8A | 6.2 | 106 | 14.1 | 1495 | 2.716 | 3.5 | 2.2 |
| 10 | Ar—1% O₂ | | | | 123 | 15.9 | 1956 | 0.951 | 4.1 | 2.4 |
| 11 | Ar—3% O₂ | | | | 110 | 13.3 | 1463 | 0.702 | 4.4 | 1.9 |
| 12 | Ar—5% O₂ | | | | 113 | 12.8 | 1446 | 0.568 | 5.2 | 2.2 |
| 13 | Ar—7% O₂ | | | | 116 | 12.9 | 1496 | 0.594 | 5.9 | 2.1 |
| 14 | Ar—9% O₂ | | | | 121 | 12.3 | 1488 | 0.814 | 5.8 | 2.1 |
| 15 | Ar—10% O₂ | | | | 125 | 12.5 | 1563 | 0.688 | 5.6 | 2.0 |

| | | | | Evaluation items | | | | | |
|---|---|---|---|---|---|---|---|---|---|
| | | Wetting | Wetting | | | | | Production | |
| Test | | angle θ_{L} | angle θ_{R} | | Generation | Stability | Wettability | and peeling | |
| No. | w/h | (°) | (°) | Arc state | of spatters | of beads | of beads | of slag | Remarks |
| 1 | 1.1 | 52 | 63 | C | A | C | C | A | Comparative Example |
| 2 | 1.9 | 85 | 81 | B | A | C | C | A | Comparative Example |
| 3 | 3.2 | 110 | 114 | B | A | B | A | A | Present inventive Example |
| 4 | 4.5 | 129 | 133 | A | A | A | A | A | Present inventive Example |
| 5 | 5.1 | 141 | 138 | A | A | A | A | A | Present inventive Example |
| 6 | 4.7 | 133 | 144 | A | A | A | A | B | Present inventive Example |
| 7 | 4.4 | 124 | 136 | A | A | B | A | C | Comparative Example |
| 8 | 4.3 | 125 | 121 | A | A | B | A | C | Comparative Example |
| 9 | 1.6 | 40 | 39 | C | C | C | C | A | Comparative Example |
| 10 | 1.7 | 68 | 61 | C | B | C | C | A | Comparative Example |
| 11 | 2.3 | 84 | 100 | A | B | C | C | A | Comparative Example |
| 12 | 2.4 | 99 | 68 | A | B | B | C | A | Comparative Example |
| 13 | 2.8 | 95 | 108 | A | B | A | C | B | Comparative Example |
| 14 | 2.8 | 97 | 98 | A | B | A | C | B | Comparative Example |
| 15 | 2.8 | 111 | 98 | A | B | A | C | B | Comparative Example |

As is apparent from the results shown in Table 5, in arc brazing in which mechanical short circuit droplet transfer is periodically carried out, in the case of using an arc welder 2 in which a wire is capable of carrying out a forward/backward moving operation relative to a workpiece as shown in FIG. 8A, spatters are seldom generated entirely. It is also apparent that it is possible to obtain beads having satisfactory wettability without causing humping beads or irregular beads having a non-uniform bead width by using a mixed gas consisting of 1.5 to 7% by volume of an oxygen gas with the remainder which is an argon gas.

On the other hand, as shown in FIG. 8B, in a conventional type arc welder 1 in which short circuit droplet transfer is carried out in the form of always feeding a wire in a workpiece direction, even when arc brazing is carried out using a shielding gas used in the present invention, an arc becomes comparatively stable, however, the improving effect is not exerted on the wettability of beads because of a large amount of the generated spatters.

By a forward/backward moving operation of a wire relative to a workpiece, in arc brazing using an arc welder 2 in which mechanical short circuit droplet transfer is periodically carried out, the improving effect is not exerted on the wettability of beads in the case of using a shielding gas consisting of only an argon gas, or a shielding gas in which the concentration of oxygen gas added to an argon gas is lower than the range of the present invention. In contrast, in the case of using a shielding gas in which the concentration of an oxygen gas added is higher than the range of the present invention, the wettability of beads is improved, but slag was drastically generated because of excessive oxidation of a molten pool.

In FIG. 10 A to FIG. 11B, a current and a voltage waveform at the time of arc brazing in Test Examples 1, 5, 9 and 12 are shown.

FIG. 10 A is a graph of a test No. 9 (Comparative Example) using a welder 1, in which a current value drastically varies and is unstable, and short circuit is irregular. FIG. 103 is a graph of a test No. 12 (Comparative Example) using a welder 1, in which variation in a current value is slightly stable, and short circuit is slightly irregular.

FIG. 11A is a graph of a test No. 1 (using an argon gas, Comparative Example) using a welder 2. FIG. 11B is a graph of a test No. 5 (the present invention) using a welder 2. In both cases, the current value is stable, short circuit is stable, and cycle is also almost stable.

### Test Example 4

### Second Aspect

As shown in FIG. 8A, by a forward/backward moving operation of a wire relative to a workpiece, arc brazing was carried out at a brazing speed of 1.0 m/min using a welder 2 in which mechanical short circuit droplet transfer is periodically carried out. Arc brazing was carried out in a posture of holding an arc torch perpendicularly to a sheet material using a hot-dip alloyed zinc-coated steel sheet having a sheet thickness of 1.0 mm.

In the test, in order to confirm an influence of an arc length on a shape of beads and bead wettability, the number of short circuit droplet transfer per second was adjusted to be within a range of from 52 to 88 times per second, thereby varying the wire feed speed and the arc length.

Arc brazing was carried out using mixed gases of an argon gas and an oxygen gas as a shielding gas, wherein the ratio of an oxygen gas thereof was changed. For comparison, an argon gas used usually in arc brazing was used.

### (Brazing Conditions)

A test was carried out under the following brazing conditions.

Brazing method: Consumable electrode type short arc (short circuit arc)
Base metal: a hot-dip alloyed zinc-coated steel sheet, sheet thickness of 0.6, 1.0 mm
Joint shape: Bead-on-plate
Wire: Copper-silicon alloy (silicon bronze) solid wire CuSi3Mn1 (EN14640:2005), diameter of 1.0 mm
Arc torch posture: Vertically downwards
Brazing speed: 1.0 m/min
Shielding gas flow rate: 15 L/min
Wire protrusion length: 12 mm
Wire feed speed: 4.0 to 7.0 m/min
Average welding current: 64 to 113 A
Average number of short circuits: 52 to 88 times/second

### (Evaluation)

The evaluation was carried out with respect to the following three points. Namely, the evaluation was carried out with respect to (i) the stability of arc, (ii) the stability of beads and (iii) the wettability of beads as factors that cause deterioration of joint performances of arc brazing. The evaluation of them was carried out based on the following evaluation criteria.

### Stability of Arc

The situation of the generation of unstable behavior associated with excessive spread of an arc was observed by a high-speed video camera. Samples in which an arc is stable were rated “A” (Pass), samples in which an arc is slightly unstable were rated “B” (Pass, although being inferior to A), and samples in which an arc is unstable were rated “C” (Failure).

Stability of Beads (the same as in Test Example 3)

By visual observation, samples in which beads are formed in a uniform bead width were rated “A” (Pass), samples in which disorder arises in a bead width were rated “B” (Pass, although being inferior to A), and samples in which a severe change occurs in a bead width and a bead height by meandering beads and humping of beads were rated “C” (Failure).

### Wettability of Beads (the Same as in Test Example 3)

By cross-section observation, the width w, the height h and the wetting angle of beads 12 shown in FIG. 9A to FIG. 9C were measured and the degree of affinity with a base metal 5 was evaluated.

In the evaluation, samples in which a (w/h) value obtained by dividing the bead width w by the bead height h is 2.5 or more and also both wetting angles (θ_{L}, θ_{R}) of right and left of beads are 110° or more were judged to have satisfactory wettability and rated “A” (Pass). Samples in which the w/h value is 2.5 or more and also both θ_{L} and θ_{R} are 100° or more and less than 110° were rated “B” (Pass, although being inferior to A). Samples in which the w/h value and both θ_{L} and θ_{R} are not within the above range were rated “C” (Failure).

Samples rated “A” (Pass) or “B” (Pass, although being inferior to A) in all evaluation items are rated “Pass” in the comprehensive evaluation, and “Present Inventive Example” are described in the remarks column in Table 6. Also, samples that do not meet the above conditions are rated “Failure”, and “Comparative Example” are described in the remarks column in the table 6.

TABLE 6

| | | | | Average | | | | | |
|---|---|---|---|---|---|---|---|---|---|
| | | | | number of | | | | | |
| | Composition | | | times of | | | | | |
| | of shielding | Sheet | Brazing | short | Average | Average arc | Heat input | | |
| | gas (% by | thickness: t | speed: v | circuit | current: I | voltage: E | amount: Q | Bead width: w | Bead height: h |
| No. | volume) | (mm) | (m/min) | (times/s) | (A) | (V) | (J/cm) | (mm) | (mm) |
| 16 | Ar | 0.6 | 1.0 | 77 | 81 | 10.8 | 525 | — | — |
| 17 | | | | 52 | 64 | 13.4 | 515 | 3.2 | 1.6 |
| 18 | | | | 59 | 68 | 12.5 | 510 | — | — |
| 19 | | | | 88 | 88 | 9.6 | 507 | — | — |
| 20 | | 1.0 | | 80 | 111 | 11.1 | 739 | 4.9 | 1.8 |
| 21 | | | | 68 | 101 | 12.6 | 764 | — | — |
| 22 | Ar—1% O₂ | 1.0 | | 77 | 109 | 10.0 | 654 | 4.4 | 2.1 |
| 23 | | | | 80 | 111 | 11.2 | 746 | 4.6 | 2.8 |
| 24 | | | | 68 | 101 | 13.5 | 818 | — | — |
| 25 | Ar—1.5% O₂ | 1.0 | | 80 | 111 | 11.3 | 753 | 5.0 | 1.8 |
| 26 | | | | 79 | 112 | 11.6 | 780 | 5.3 | 2.1 |
| 27 | Ar—2% O₂ | 0.6 | | 78 | 81 | 11.8 | 573 | 6.1 | 1.1 |
| 28 | | | | 56 | 66 | 14.4 | 570 | 4.9 | 1.1 |
| 29 | | | | 53 | 64 | 15.0 | 576 | 4.3 | 1.0 |
| 30 | | | | 88 | 88 | 9.9 | 523 | 5.6 | 1.3 |
| 31 | | 1.0 | | 81 | 113 | 11.5 | 780 | 5.8 | 1.5 |
| 32 | | | | 70 | 102 | 14.2 | 869 | 5.5 | 1.2 |
| 33 | | | | 61 | 95 | 15.0 | 855 | 5.4 | 1.2 |
| 34 | Ar—3% O₂ | 0.6 | | 78 | 82 | 12.2 | 600 | 6.6 | 1.0 |
| 35 | | | | 69 | 75 | 13.0 | 585 | 5.9 | 0.9 |
| 36 | | | | 53 | 64 | 15.0 | 576 | 5.0 | 0.9 |
| 37 | | | | 87 | 88 | 10.1 | 533 | 5.7 | 1.2 |
| 38 | | 1.0 | | 81 | 112 | 11.2 | 753 | 6.0 | 1.3 |
| 39 | | | | 70 | 102 | 14.4 | 881 | 6.3 | 1.1 |
| 40 | | | | 61 | 94 | 15.2 | 857 | 5.8 | 1.2 |
| 41 | Ar—5% O₂ | 0.6 | | 79 | 82 | 11.8 | 581 | 6.8 | 0.8 |
| 42 | | | | 53 | 64 | 14.6 | 561 | 4.7 | 0.9 |
| 43 | | | | 88 | 88 | 10.6 | 560 | 7.2 | 0.8 |
| 44 | | | | 59 | 68 | 13.8 | 563 | 5.3 | 0.8 |
| 45 | | 1.0 | | 79 | 110 | 11.6 | 766 | 6.2 | 1.3 |
| 46 | | | | 70 | 102 | 14.6 | 894 | 6.7 | 1.1 |
| 47 | | | | 61 | 94 | 15.8 | 891 | 6.6 | 1.0 |
| 48 | Ar—7% O₂ | 0.6 | | 59 | 69 | 14.1 | 584 | 5.6 | 0.9 |
| 49 | | | | 53 | 64 | 14.7 | 564 | 5.1 | 0.9 |
| 50 | | | | 85 | 86 | 11.3 | 583 | 6.9 | 0.9 |
| 51 | | | | 81 | 84 | 11.8 | 595 | 7.0 | 0.8 |
| 52 | | 1.0 | | 70 | 102 | 14.5 | 887 | 7.0 | 1.1 |
| 53 | | | | 61 | 94 | 15.7 | 885 | 6.5 | 1.1 |

| | | Wetting | Wetting | Evaluation items | | | |
|---|---|---|---|---|---|---|---|
| | | angle θ_{L} | angle θ_{R} | | Stability of | Wettability | |
| No. | w/h | (°) | (°) | Arc state | beads | of beads | Remarks |
| 16 | — | — | — | C | C, Humping | C | Comparative Example |
| 17 | 1.9 | 76 | 65 | C | C, Humping | C | Comparative Example |
| 18 | — | — | — | C | C, Humping | C | Comparative Example |
| 19 | — | — | — | C | C, Humping | C | Comparative Example |
| 20 | 2.7 | 84 | 95 | C | C | C | Comparative Example |
| 21 | — | — | — | C | C, Humping | C | Comparative Example |
| 22 | 2.2 | 74 | 87 | B | C | C | Comparative Example |
| 23 | 1.6 | 56 | 56 | C | C | C | Comparative Example |
| 24 | — | — | — | C | C, Humping | C | Comparative Example |
| 25 | 2.8 | 106 | 103 | B | A | B | Present inventive Example |
| 26 | 2.6 | 102 | 101 | B | A | B | Present inventive Example |
| 27 | 5.4 | 136 | 136 | A | A | A | Present inventive Example |
| 28 | 4.6 | 134 | 133 | B | B | A | Present inventive Example |
| 29 | 4.2 | 127 | 126 | C | C | A | Comparative Example |
| 30 | 4.5 | 123 | 125 | C | B | A | Comparative Example |
| 31 | 3.9 | 125 | 117 | A | A | A | Present inventive Example |
| 32 | 4.5 | 130 | 124 | A | A | A | Present inventive Example |
| 33 | 4.5 | 130 | 129 | A | A | A | Present inventive Example |
| 34 | 6.9 | 151 | 144 | A | A | A | Present inventive Example |
| 35 | 6.5 | 145 | 143 | A | A | A | Present inventive Example |
| 36 | 5.4 | 141 | 130 | C | C | A | Comparative Example |
| 37 | 5.0 | 127 | 127 | C | B | A | Comparative Example |
| 38 | 4.8 | 125 | 121 | A | A | A | Present inventive Example |
| 39 | 5.7 | 135 | 135 | A | A | A | Present inventive Example |
| 40 | 5.0 | 137 | 135 | A | A | A | Present inventive Example |
| 41 | 8.2 | 150 | 147 | A | A | A | Present inventive Example |
| 42 | 5.5 | 141 | 143 | C | C | A | Comparative Example |
| 43 | 8.6 | 152 | 151 | C | B | A | Comparative Example |
| 44 | 6.3 | 143 | 137 | A | A | A | Present inventive Example |
| 45 | 4.9 | 112 | 142 | A | A | A | Present inventive Example |
| 46 | 6.0 | 139 | 144 | A | A | A | Present inventive Example |
| 47 | 6.6 | 149 | 152 | A | A | A | Present inventive Example |
| 48 | 6.2 | 146 | 140 | A | B | A | Present inventive Example |
| 49 | 6.0 | 143 | 143 | C | C | A | Comparative Example |
| 50 | 7.8 | 152 | 147 | A | A | A | Present inventive Example |
| 51 | 8.7 | 151 | 148 | A | A | A | Present inventive Example |
| 52 | 6.5 | 145 | 152 | A | A | A | Present inventive Example |
| 53 | 6.2 | 147 | 146 | A | A | A | Present inventive Example |

As is apparent from the results shown in Table 6, it is possible to obtain beads having satisfactory wettability without causing humping beads or irregular beads having a non-uniform bead width by a forward/backward moving operation of a wire relative to a workpiece in arc brazing in which mechanical short circuit droplet transfer is periodically carried out, in a test (number of times of short circuit droplet transfer per second: within a range of from 56 to 85 times) wherein a mixed gas consisting of 1.5 to 7% by volume of an oxygen gas and the remainder which is an argon gas is used.

On the other hand, in case the number of times of short circuit droplet transfer deviates from the above range and the shielding gas consists only of an argon gas, or a shielding gas in which the concentration of an oxygen gas added in an argon gas is lower than the range of the present invention is used, the improving effect is not exerted on the wettability of beads.

### Test Example 5

### Third Aspect and Fourth Aspect

Using a hot-dip alloyed zinc-coated steel sheet having a sheet thickness of 0.6 to 1.4 mm, welding of lap joint was carried out. After setting a gap between an upper sheet and a lower sheet to 0 mm, a welder in which mechanical short circuit droplet transfer is periodically carried out by a forward/backward moving operation of a wire relative to a workpiece shown in FIG. 8A was used. Arc brazing was carried out at a brazing speed of 0.6 to 1.5 m/min, and an influence of an amount of heat input applied to a base metal on a bead shape and bead wettability was confirmed.

As a shielding gas, a mixed gas of an argon gas and an oxygen gas, a mixed gas of an argon gas, an oxygen gas and a nitrogen gas (crude argon gas), and a mixed gas of an argon gas, an oxygen gas and a helium gas were used. An argon gas was used as a main gas and the ratio of an additive gas was changed to carry out arc brazing. For comparison, an argon gas used usually in arc brazing was used.

### (Brazing Conditions)

A test was carried out under the following brazing conditions.

Brazing method: Consumable electrode type short arc (short circuit arc)
Base metal: Hot-dip alloyed zinc-coated steel sheet, sheet thickness of 0.6 to 1.4 mm
Joint shape: Lap joint (gap between sheets: 0 mm)
Wire: Copper-silicon alloy (silicon bronze) solid wire CuSi3Mn1 (EN14640:2005), diameter: 1.0 mm
Brazing speed: 0.6 to 1.5 m/min
Arc torch forward angle: 5°
Arc torch slope angle: 30°
Shielding gas flow rate: 15 L/min
Wire protrusion length: 12 mm
Wire feed speed: 3.0 to 11.0 m/min
Average welding current: 40 to 175 A
Average number of short circuits: 59 to 82 times/second

### (Evaluation)

The evaluation was carried out with respect to the following four points. Namely, the evaluation was carried out with respect to (i) the stability of arc, (ii) spatters, (iii) the stability of beads, and (iv) the wettability of beads as factors that cause deterioration of joint performances of arc brazing. The evaluation of them was carried out based on the following evaluation criteria.

### Stability of Arc

The situation of the generation of unstable behavior associated with excessive spread of an arc was observed by a high-speed video camera. Samples in which an arc is stable were rated “A” (Pass), samples in which an arc is slightly unstable were rated “B” (Pass, although being inferior to A), and samples in which an arc is unstable were rated “C” (Failure).

### Spatters

The situation of scatter was visually confirmed. Samples in which scatter is scarcely recognized were rated “A” (Pass), samples in which scatter is slightly recognized were rated “B” (Pass, although being inferior to A), and samples in which spatters drastically scatter and spatters in the form of large particles (1.0 mm or more) are generated were rated “C” (Failure).

### Stability of Beads

By visual observation, samples in which beads are formed in a uniform bead width were rated “A” (Pass), samples in which disorder arises in a bead width were rated “B” (Pass, although being inferior to A), and samples in which a severe change occurs in the bead width and the bead height by meandering beads and humping of beads were rated “C” (Failure).

### Wettability of Beads

By visual observation of cross-section, the bead width w, the leg length l, the upper sheet wet length a (length of contact between an upper sheet and a deposited metal) and the wetting angle B of beads shown in FIG. 12R and FIG. 12B were measured and the joined state between a deposited metal and a base material, that exerts an influence on joint strength, was evaluated.

In the evaluation, samples in which a bead width w is two or more times the sheet thickness t, the leg length l is at least 1.5 times the sheet thickness t, the a/t value obtained by dividing the upper sheet wet length a (a length of contact between an upper sheet and a deposited metal) by the sheet thickness t is 1.5 or more, and the bead wetting angle θ is 120° or more are judged to have satisfactory wettability and rated “A” (Pass). Samples in which the bead width w is two or more times the sheet thickness the leg length l is at least 1.5 times the sheet thickness t, the a/t value is 1.5 or more and the bead wetting angle θ is 110° or more and less than 120° were rated “B” (Pass, although being inferior to A), and samples in which the above values are not within the above range were rated “C” (Failure).

Samples rated “A” (Pass) or “B” (Pass, although being inferior to A) in all evaluation items are rated “Pass” in the comprehensive evaluation, and “Present Inventive Example” are described in the remarks column in Table. Also, samples that do not meet the above conditions are rated “Failure”, and “Comparative Example” are described in the remarks column in the table.

TABLE 7

| | Composition | | | Average number | | | | | |
|---|---|---|---|---|---|---|---|---|---|
| | of shielding | Sheet | Brazing | of times of | Average | Average arc | Heat input | Bead | Leg |
| | gas (% by | thickness: t | speed: v | short circuit | current: I | voltage: E | amount: Q | width: w | length: l |
| Test No. | volume) | (mm) | (m/min) | (times/s) | (A) | (V) | (J/cm) | (mm) | (mm) |
| 54 | Ar | 0.6 | 0.6 | 71 | 61 | 9.7 | 592 | — | — |
| 55 | | 0.6 | 0.6 | 74 | 106 | 10.0 | 1060 | 8.8 | 6.5 |
| 56 | | 0.6 | 1.0 | 72 | 111 | 11.4 | 759 | — | — |
| 57 | | 0.6 | 1.0 | 80 | 147 | 16.3 | 1438 | 9.0 | 7.5 |
| 58 | | 0.6 | 1.5 | 78 | 156 | 17.3 | 1080 | 7.4 | 6.2 |
| 59 | | 0.6 | 1.5 | 72 | 119 | 13.1 | 624 | — | — |
| 60 | | 1.0 | 0.6 | 78 | 87 | 9.9 | 861 | 4.9 | 3.4 |
| 61 | | 1.0 | 0.6 | 81 | 148 | 15.1 | 2235 | 10.2 | 7.1 |
| 62 | | 1.0 | 0.6 | 76 | 76 | 9.7 | 737 | — | — |
| 63 | | 1.0 | 1.0 | 77 | 115 | 11.0 | 759 | 4.5 | 3.9 |
| 64 | | 1.0 | 1.0 | 80 | 160 | 15.5 | 1488 | 7.6 | 5.6 |
| 65 | | 1.0 | 1.5 | 77 | 140 | 14.8 | 829 | — | — |
| 66 | | 1.0 | 1.5 | 78 | 170 | 17.4 | 1183 | 6.0 | 4.8 |
| 67 | | 1.4 | 0.6 | 75 | 115 | 10.7 | 1231 | — | — |
| 68 | | 1.4 | 0.6 | 81 | 150 | 15.1 | 2265 | 7.8 | 5.8 |
| 69 | | 1.4 | 1.0 | 79 | 132 | 12.5 | 990 | 4.2 | 3.1 |
| 70 | | 1.4 | 1.0 | 80 | 162 | 16.2 | 1575 | 6.2 | 4.9 |
| 71 | | 1.4 | 1.5 | 79 | 175 | 17.6 | 1232 | 5.4 | 4.1 |
| 72 | Ar—2% O₂ | 0.6 | 0.6 | 63 | 42 | 10.6 | 445 | — | — |
| 73 | | 0.6 | 0.6 | 72 | 64 | 9.9 | 634 | 5.8 | 4.7 |
| 74 | | 0.6 | 1.0 | 70 | 100 | 10.1 | 606 | 5.7 | 5.2 |
| 75 | | 0.6 | 1.0 | 75 | 116 | 11.8 | 821 | 6.9 | 5.6 |
| 76 | | 0.6 | 1.5 | 78 | 128 | 13.4 | 686 | 5.6 | 5.2 |
| 77 | | 0.6 | 1.5 | 77 | 142 | 15.8 | 897 | 6.4 | 5.8 |
| 78 | | 0.6 | 1.5 | 59 | 103 | 10.8 | 445 | — | — |
| 79 | | 1.0 | 0.6 | 72 | 61 | 10.3 | 628 | — | — |
| 80 | | 1.0 | 0.6 | 75 | 76 | 10.6 | 806 | 5.7 | 4.6 |
| 81 | | 1.0 | 0.6 | 75 | 114 | 11.9 | 1357 | 8.3 | 6.3 |
| 82 | | 1.0 | 0.6 | 80 | 144 | 15.5 | 2232 | 10.2 | 7.2 |
| 83 | | 1.0 | 1.0 | 73 | 112 | 11.3 | 759 | 5.3 | 4.6 |
| 84 | | 1.0 | 1.0 | 81 | 145 | 15.7 | 1366 | 7.4 | 5.8 |
| 85 | | 1.0 | 1.5 | 80 | 133 | 13.5 | 718 | — | — |
| 86 | | 1.0 | 1.5 | 80 | 147 | 16.1 | 947 | 5.7 | 4.8 |
| 87 | | 1.0 | 1.5 | 78 | 171 | 18.1 | 1238 | 6.8 | 5.2 |
| 88 | | 1.4 | 0.6 | 78 | 88 | 10.4 | 915 | — | — |
| 89 | | 1.4 | 0.6 | 75 | 116 | 11.9 | 1380 | 6.6 | 4.9 |
| 90 | | 1.4 | 0.6 | 80 | 149 | 15.9 | 2369 | 8.8 | 5.8 |
| 91 | | 1.4 | 0.6 | 79 | 133 | 13.6 | 1809 | 8.0 | 5.8 |
| 92 | | 1.4 | 1.0 | 79 | 133 | 13.1 | 1045 | 5.6 | 4.2 |
| 93 | | 1.4 | 1.0 | 81 | 163 | 17.7 | 1731 | 7.3 | 5.2 |

| | Upper sheet | | | Evaluation items | | | | |
|---|---|---|---|---|---|---|---|---|
| | wet length: a | | Wetting | | | Stability of | Wettability | |
| Test No. | (mm) | a/t | angle θ (°) | Arc state | Spatters | beads | of beads | Remarks |
| 54 | — | — | — | C | B | C, Irregular | C | Comparative Example |
| | | | | | | beads | | |
| 55 | 2.8 | 4.7 | 133 | C | C | C, Irregular | A | Comparative Example |
| | | | | | | beads | | |
| 56 | — | — | — | C | C, Large | C, Irregular | C | Comparative Example |
| | | | | | particles | beads | | |
| 57 | 2.6 | 4.3 | 139 | C | C, Large | C, Irregular | A | Comparative Example |
| | | | | | particles | beads | | |
| 58 | 1.6 | 2.7 | 144 | C | C, Large | A | A | Comparative Example |
| | | | | | particles | | | |
| 59 | — | — | — | C | A | C, Irregular | C | Comparative Example |
| 60 | 2.5 | 2.5 | 81 | C | B | C, Irregular | C | Comparative Example |
| | | | | | | beads | | |
| 61 | 3.5 | 3.5 | 124 | C | C, Large | C, Irregular | A | Comparative Example |
| | | | | | particles | beads | | |
| 62 | — | — | — | C | C | C, Irregular | C | Comparative Example |
| | | | | | | beads | | |
| 63 | 1.5 | 1.5 | 90 | C | A | C, Irregular | C | Comparative Example |
| | | | | | | beads | | |
| 64 | 2.9 | 2.9 | 136 | C | C, Large | B | A | Comparative Example |
| | | | | | particles | | | |
| 65 | — | — | — | C | B | C, Humping | C | Comparative Example |
| 66 | 1.9 | 1.9 | 129 | C | C | C, Irregular | A | Comparative Example |
| | | | | | | beads | | |
| 67 | — | — | — | C | B | C, | C | Comparative Example |
| | | | | | | Separation | | |
| | | | | | | of sheets | | |
| 68 | 3.1 | 2.2 | 111 | C | C | A | B | Comparative Example |
| 69 | 2.3 | 1.7 | 66 | C | A | C, Irregular | C | Comparative Example |
| | | | | | | beads | | |
| 70 | 2.4 | 1.7 | 125 | C | C | A | A | Comparative Example |
| 71 | 2.3 | 1.6 | 109 | C | C, Large | A | C | Comparative Example |
| | | | | | particles | | | |
| 72 | — | — | — | C | A | C, Irregular | C | Comparative Example |
| | | | | | | beads | | |
| 73 | 1.6 | 2.7 | 124 | A | A | A | A | Present inventive Example |
| 74 | 1.1 | 1.9 | 130 | A | A | A | A | Present inventive Example |
| 75 | 1.8 | 3.0 | 138 | A | A | A | A | Present inventive Example |
| 76 | 1.1 | 1.8 | 139 | A | A | A | A | Present inventive Example |
| 77 | 1.2 | 2.0 | 138 | A | A | A | A | Present inventive Example |
| 78 | — | — | — | C | A | C, Irregular | C | Comparative Example |
| | | | | | | beads | | |
| 79 | — | — | — | C | A | C, Humping | C | Comparative Example |
| 80 | 2.1 | 2.1 | 115 | A | A | A | B | Present inventive Example |
| 81 | 2.8 | 2.8 | 128 | A | A | A | A | Present inventive Example |
| 82 | 3.8 | 3.8 | 134 | C | C | A | A | Comparative Example |
| 83 | 1.7 | 1.7 | 118 | A | A | A | B | Present inventive Example |
| 84 | 2.5 | 2.5 | 135 | A | B | A | A | Present inventive Example |
| 85 | — | — | — | C | C | C, Irregular | C | Comparative Example |
| | | | | | | beads | | |
| 86 | 1.8 | 1.8 | 131 | A | A | A | A | Present inventive Example |
| 87 | 2.2 | 2.2 | 141 | C | C, Large | A | A | Comparative Example |
| | | | | | particles | | | |
| 88 | — | — | — | A | A | C, | C | Comparative Example |
| | | | | | | Separation | | |
| | | | | | | of sheets | | |
| 89 | 2.8 | 2.0 | 116 | A | A | A | B | Present inventive Example |
| 90 | 3.6 | 2.6 | 124 | C | C, Large | A | A | Comparative Example |
| | | | | | particles | | | |
| 91 | 3.2 | 2.3 | 122 | A | A | A | A | Present inventive Example |
| 92 | 2.4 | 1.7 | 124 | A | A | A | A | Present inventive Example |
| 93 | 2.8 | 2.0 | 133 | C | C, Large | A | A | Comparative Example |
| | | | | | particles | | | |

TABLE 8

| | Composition | | | Average number | | | | | |
|---|---|---|---|---|---|---|---|---|---|
| | of shielding | Sheet | Brazing | of times of | Average | Average arc | Heat input | Bead | Leg |
| | gas (% by | thickness: t | speed: v | short circuits | current: I | voltage: E | amount: Q | width: w | length: l |
| Test No. | volume) | (mm) | (m/min) | (times/s) | (A) | (V) | (J/cm) | (mm) | (mm) |
| 94 | Ar—2% O₂—0.05% | 1.0 | 0.6 | 77 | 86 | 10.4 | 894 | 5.8 | 4.9 |
| | N₂ | | | | | | | | |
| 95 | Ar—2% O₂—15% He | 1.0 | 0.6 | 77 | 86 | 10.5 | 903 | 5.9 | 4.7 |
| 96 | | 1.0 | 1.0 | 78 | 129 | 13.0 | 1006 | 6.0 | 5.0 |
| 97 | | 1.0 | 1.5 | 81 | 148 | 16.6 | 983 | 5.1 | 4.4 |
| 98 | Ar—2% O₂—15% He | 1.0 | 0.6 | 78 | 86 | 10.5 | 903 | 6.0 | 4.8 |
| 99 | | 1.0 | 1.0 | 80 | 131 | 13.4 | 1053 | 6.3 | 5.2 |
| 100 | | 1.0 | 1.5 | 80 | 149 | 16.5 | 983 | 6.1 | 4.9 |
| 101 | Ar—5% O₂ | 0.6 | 0.6 | 64 | 40 | 12.0 | 480 | — | — |
| 102 | | 0.6 | 0.6 | 72 | 63 | 10.8 | 680 | 6.2 | 5.1 |
| 103 | | 0.6 | 1.5 | 80 | 146 | 16.3 | 952 | 6.8 | 5.4 |
| 104 | | 0.6 | 1.5 | 77 | 156 | 16.9 | 1055 | 7.0 | 5.4 |
| 105 | | 1.0 | 0.6 | 71 | 62 | 10.4 | 645 | — | — |
| 106 | | 1.0 | 0.6 | 78 | 86 | 11.1 | 955 | 6.5 | 5.2 |
| 107 | | 1.0 | 0.6 | 79 | 132 | 14.3 | 1888 | 9.3 | 6.7 |
| 108 | | 1.0 | 0.6 | 71 | 112 | 12.5 | 1400 | 8.5 | 6.2 |
| 109 | | 1.0 | 1.0 | 79 | 133 | 14.2 | 1133 | 7.1 | 5.5 |
| 110 | | 1.0 | 1.5 | 80 | 148 | 16.6 | 983 | 6.2 | 4.6 |
| 111 | | 1.0 | 1.5 | 80 | 161 | 17.6 | 1133 | 6.7 | 4.8 |
| 112 | | 1.4 | 0.6 | 73 | 114 | 12.3 | 1402 | 7.6 | 5.4 |
| 113 | | 1.4 | 0.6 | 78 | 131 | 14.7 | 1926 | 8.1 | 5.7 |
| 114 | | 1.4 | 1.0 | 76 | 117 | 12.3 | 863 | 5.1 | 4.0 |
| 115 | | 1.4 | 1.0 | 77 | 132 | 13.9 | 1101 | 5.9 | 4.4 |
| 116 | Ar—5% O₂—0.1% N₂ | 0.6 | 1.5 | 79 | 133 | 13.9 | 739 | 5.6 | 5.0 |
| 117 | Ar—5% O₂—10% He | 1.0 | 0.6 | 77 | 86 | 11.1 | 955 | 6.3 | 5.1 |
| 118 | | 1.0 | 1.0 | 78 | 125 | 13.5 | 1013 | 6.8 | 5.3 |
| 119 | | 1.0 | 1.5 | 82 | 142 | 15.2 | 863 | 5.8 | 4.2 |
| 120 | Ar—5% O₂—30% He | 1.0 | 1.5 | 81 | 142 | 15.4 | 875 | 6.0 | 4.4 |

| | Upper sheet | | | Evaluation items | | | | |
|---|---|---|---|---|---|---|---|---|
| | wet length: a | | Wetting | | | Stability of | Wettability | |
| Test No. | (mm) | a/t | angle θ (°) | Arc state | Spatters | beads | of beads | Remarks |
| 94 | 1.8 | 1.8 | 121 | A | A | A | A | Present inventive Example |
| 95 | 2.1 | 2.1 | 118 | A | A | A | B | Present inventive Example |
| 96 | 1.9 | 1.9 | 126 | A | A | A | A | Present inventive Example |
| 97 | 1.6 | 1.6 | 127 | A | B | A | A | Present inventive Example |
| 98 | 2.2 | 2.2 | 115 | A | A | A | B | Present inventive Example |
| 99 | 2.0 | 2.0 | 125 | A | A | A | A | Present inventive Example |
| 100 | 2.0 | 2.0 | 141 | A | B | A | A | Present inventive Example |
| 101 | — | — | — | C | A | C, Irregular | C | Comparative Example |
| | | | | | | beads | | |
| 102 | 1.7 | 2.8 | 135 | A | A | A | A | Present inventive Example |
| 103 | 1.8 | 2.9 | 142 | A | A | A | A | Present inventive Example |
| 104 | 2.1 | 3.6 | 148 | C | C, Large | A | A | Comparative Example |
| | | | | | particles | | | |
| 105 | — | — | — | A | A | C, Irregular | C | Comparative Example |
| | | | | | | beads | | |
| 106 | 2.2 | 2.2 | 122 | A | A | A | A | Present inventive Example |
| 107 | 3.1 | 3.1 | 147 | C | C, Large | A | A | Comparative Example |
| | | | | | particles | | | |
| 108 | 2.8 | 2.8 | 142 | A | B | A | A | Present inventive Example |
| 109 | 2.3 | 2.3 | 139 | A | B | A | A | Present inventive Example |
| 110 | 2.2 | 2.2 | 139 | A | B | A | A | Present inventive Example |
| 111 | 2.4 | 2.4 | 144 | C | C | A | A | Comparative Example |
| 112 | 3.1 | 2.2 | 125 | A | A | A | A | Present inventive Example |
| 113 | 3.1 | 2.2 | 128 | A | B | A | A | Present inventive Example |
| 114 | 2.4 | 1.7 | 106 | A | A | A | C | Comparative Example |
| 115 | 2.4 | 1.7 | 115 | A | B | A | B | Present inventive Example |
| 116 | 1.2 | 2.0 | 130 | A | A | A | A | Present inventive Example |
| 117 | 2.1 | 2.1 | 125 | A | A | A | A | Present inventive Example |
| 118 | 2.3 | 2.3 | 136 | A | A | A | A | Present inventive Example |
| 119 | 2.2 | 2.2 | 134 | A | B | A | A | Present inventive Example |
| 120 | 2.2 | 2.2 | 141 | C | C, Large | A | A | Comparative Example |
| | | | | | particles | | | |

TABLE 9

| | Composition | | | Average number | | | | | |
|---|---|---|---|---|---|---|---|---|---|
| | of shielding | Sheet | Brazing | of times of | Average | Average arc | Heat input | Bead | Leg |
| | gas (% by | thickness: t | speed: v | short circuits | current: I | voltage: E | amount: Q | width: w | length: l |
| Test No. | volume) | (mm) | (m/min) | (times/s) | (A) | (V) | (J/cm) | (mm) | (mm) |
| 121 | Ar—7% O₂ | 0.6 | 0.6 | 65 | 40 | 12.3 | 492 | — | — |
| 122 | | 0.6 | 0.6 | 72 | 63 | 11.2 | 706 | 6.9 | 5.3 |
| 123 | | 0.6 | 1.0 | 73 | 83 | 10.3 | 513 | 4.8 | 4.1 |
| 124 | | 0.6 | 1.0 | 75 | 107 | 11.0 | 706 | 6.7 | 5.2 |
| 125 | | 0.6 | 1.5 | 79 | 132 | 14.1 | 744 | 5.9 | 5.1 |
| 126 | | 0.6 | 1.5 | 80 | 148 | 16.6 | 983 | 7.5 | 5.8 |
| 127 | | 1.0 | 0.6 | 78 | 88 | 11.4 | 1003 | 6.6 | 5.0 |
| 128 | | 1.0 | 0.6 | 71 | 113 | 12.3 | 1390 | 8.3 | 6.0 |
| 129 | | 1.0 | 0.6 | 79 | 131 | 14.8 | 1939 | 9.3 | 6.8 |
| 130 | | 1.0 | 1.0 | 79 | 133 | 14.3 | 1141 | 7.1 | 5.7 |
| 131 | | 1.0 | 1.0 | 76 | 116 | 12.4 | 863 | 6.1 | 4.9 |
| 132 | | 1.0 | 1.5 | 80 | 148 | 16.5 | 977 | 5.8 | 4.5 |
| 133 | | 1.0 | 1.5 | 79 | 159 | 16.8 | 1068 | 6.4 | 5.1 |
| 134 | | 1.4 | 0.6 | 60 | 96 | 14.2 | 1363 | 5.9 | 4.8 |
| 135 | | 1.4 | 0.6 | 75 | 119 | 16.2 | 1928 | 8.2 | 6.1 |
| 136 | | 1.4 | 0.6 | 78 | 145 | 16.8 | 2436 | 9.1 | 5.8 |
| 137 | | 1.4 | 1.0 | 79 | 133 | 14.0 | 1117 | 5.9 | 4.5 |
| 138 | Ar—7% O₂—15% He | 1.0 | 0.6 | 80 | 88 | 11.6 | 1021 | 6.6 | 4.9 |
| 139 | | 1.0 | 1.0 | 76 | 116 | 12.3 | 856 | 6.4 | 4.8 |
| 140 | | 1.0 | 1.5 | 79 | 133 | 14.1 | 750 | 5.3 | 4.0 |

| | Upper sheet | | | Evaluation items | | | | |
|---|---|---|---|---|---|---|---|---|
| | wet length: a | | Wetting | | | Stability of | Wettability | |
| Test No. | (mm) | a/t | angle θ (°) | Arc state | Spatters | beads | of beads | Remarks |
| 121 | — | — | — | C | A | C, Irregular | C | Comparative Example |
| | | | | | | beads | | |
| 122 | 2.0 | 3.4 | 143 | A | A | A | A | Present inventive Example |
| 123 | 1.2 | 2.1 | 119 | A | A | A | B | Present inventive Example |
| 124 | 1.8 | 3.0 | 149 | A | B | A | A | Present inventive Example |
| 125 | 1.4 | 2.3 | 137 | A | A | A | A | Present inventive Example |
| 126 | 2.0 | 3.3 | 151 | A | B | A | A | Present inventive Example |
| 127 | 2.4 | 2.4 | 126 | A | A | A | A | Present inventive Example |
| 128 | 2.7 | 2.7 | 125 | A | A | A | A | Present inventive Example |
| 129 | 3.5 | 3.5 | 147 | C | C, Large | A | A | Comparative Example |
| | | | | | particles | | | |
| 130 | 2.1 | 2.1 | 130 | A | B | A | A | Present inventive Example |
| 131 | 2.0 | 2.0 | 133 | A | A | A | A | Present inventive Example |
| 132 | 2.0 | 2.0 | 142 | A | B | A | A | Present inventive Example |
| 133 | 2.2 | 2.2 | 140 | C | C, Large | A | A | Comparative Example |
| | | | | | particles | | | |
| 134 | 2.2 | 1.6 | 124 | A | A | A | A | Present inventive Example |
| 135 | 2.9 | 2.0 | 126 | A | A | A | A | Present inventive Example |
| 136 | 3.9 | 2.8 | 120 | C | C, Large | A | A | Comparative Example |
| | | | | | particles | | | |
| 137 | 2.4 | 1.7 | 121 | A | B | A | A | Present inventive Example |
| 138 | 2.4 | 2.4 | 115 | A | A | A | B | Present inventive Example |
| 139 | 2.4 | 2.4 | 133 | A | A | A | A | Present inventive Example |
| 140 | 2.1 | 2.1 | 132 | A | B | A | A | Present inventive Example |

As is apparent from the results shown in Table 7 to Table 9, it is possible to obtain beads having satisfactory wettability without causing large spatters, humping beads, and irregular beads having a non-uniform bead width, when mechanical short circuit droplet transfer is periodically carried out by a forward/backward moving operation of a wire relative to a workpiece wherein arc brazing of a lap joint of zinc coated steel sheets having a sheet thickness of 0.6 to 1.4 mm is performed using a mixed gas consisting of 2.0 to 7.0% by volume of an oxygen gas and the remainder, which is an argon gas.

It is also apparent that the similar effect is obtained even in the case of mixing the above mixed gas with 15% by volume or less of a helium gas, and that the similar effect is obtained even in the case of using a crude argon gas containing an oxygen gas within the above range and 0.1% by volume or less of a nitrogen gas.

At this time, satisfactory results satisfied the conditions in which the average welding current is from 60 to 150 A and the heat input amount Q (J/cm) is within a range of the following conditional expression determined according to a sheet thickness of the material to be joined:

625×t+125≦Q≦1,250×t+250

wherein t represents a sheet thickness (mm) of a steel sheet.

In case the shielding gas consists only of an argon gas or a shielding gas in which the concentration of an oxygen gas in an argon gas is lower than that range of the second and third aspects of the present invention is used, satisfactory results cannot be obtained even when a welding current and a heat input amount are within the above ranges. Furthermore, when a helium gas is added in a concentration of more than 15% by volume, droplets do not transfer to a workpiece by short circuit and are continuously released from a wire like spray transfer. Therefore, when a brazing speed is increased, an arc becomes unstable and a bead width is likely to become non-uniform, and also spatters are likely to be generated.

### INDUSTRIAL APPLICABILITY

In a method of arc brazing of a steel sheet, it is possible to prevent the generation of spatters caused by an unstable arc phenomenon, the generation of bead irregularity due to an excessive concentration of arc, the generation of discoloration due to oxidation of a surface of beads and wrinkling of beads, and also to prevent burn through and no gap bridging which are caused by gap and target missing.

In a consumable electrode type arc brazing of a steel sheet, it is possible to improve the wettability of beads and to reduce the generation of spatters without using a special combined wire, and flat beads having a uniform bead width can be obtained.

### BRIEF DESCRIPTION OF THE REFERENCE SIGNS

1: Welding torch
2: Gas nozzle
3: Contact chip
4: Wire
5: Base metal
6: Welding source device
12: Bead
Ip: Peak current
Ib: Base current
Tp: Pulse time
Tb: Base current time
Tdown: Pulse fall time
Ts: Short circuit droplet transfer time
w: Bead width
l: Leg length
a: Upper sheet wet length
θ: Wetting angle of beads
θ_{L}: Left side wetting angle
θ_{R}: Right side wetting angle

1. A method of gas-shielded arc brazing of a steel sheet; wherein
a solid wire containing copper, as a main component, and aluminum is used in arc brazing of a steel sheet; and
the method comprising
periodically carrying out pulse droplet transfer and short circuit droplet transfer in arc brazing using, as a shielding gas, a mixed gas consisting of 0.03 to 0.3% by volume of oxygen gas and the remainder which is argon.

2. The method of gas-shielded arc brazing of a steel sheet according to claim 1, wherein three or more times of the pulse droplet transfer and one time of the short circuit droplet transfer are periodically carried out as one cycle, and a pulse fall time from a peak current to a base current is from 3.1 to 8.4 ms.

3. The method of gas-shielded arc brazing of a steel sheet according to claim 1, wherein the gas-shielded arc brazing is carried out at a joint in which two or more sheet materials are laid one upon another, and a target position of a wire is set within a range between the point that is 1 mm apart from the intersection point toward the lower sheet side and the point that is 2 mm apart from the intersection point toward the upper sheet side, wherein the intersection point is a point where the perpendicular drawn from an upper sheet end of a sheet material located on the uppermost side of the sheet materials laid one upon another meets a top surface of a lower sheet located on the lowermost side of the sheet materials.

4. The method of gas-shielded arc brazing of a steel sheet according to claim 1, wherein the gas-shielded arc brazing is carried out at a joint in which two or more sheet materials are laid one upon another, and a gap between sheet materials is set to 2.0 mm or less, or a gap between sheet materials is two times or less a sheet thickness of the lower sheet material located on the lowermost side of the joint.

5. The method of gas-shielded arc brazing of a steel sheet according to claim 3, wherein a heat input amount is set within a range of from 700 to 1,800 J/cm.

6. A method of gas-shielded arc brazing of a steel sheet, wherein
a copper alloy wire containing copper, as a main component, silicon and manganese is used in arc brazing of a steel sheet; and
the method comprising
periodically carrying out short circuit droplet transfer by a forward/backward moving operation of the wire relative to a workpiece in arc brazing using, as a shielding gas, a mixed gas consisting of 1.5 to 7% by volume of an oxygen gas and the remainder which is an argon gas.

7. A method of gas-shielded arc brazing of a steel sheet; wherein
a copper alloy wire containing copper, as a main component, silicon and manganese is used in arc brazing of a steel sheet; and
the method comprising
periodically carrying out short circuit droplet transfer by a forward/backward moving operation of the wire relative to a workpiece in arc brazing using, as a shielding gas, a mixed gas consisting of 2 to 7% by volume of an oxygen gas, 15% by volume or less of a helium gas and the remainder which is an argon gas.

8. The method of gas-shielded arc brazing of a steel sheet according to claim 6, wherein the argon gas is a crude argon gas containing an oxygen gas and a nitrogen gas as impurities.

9. The method of gas-shielded arc brazing of a steel sheet according to claim 6, wherein the number short circuits per second in the short circuit droplet transfer is set to be within a range of from 55 to 85 times.

10. The method of gas-shielded arc brazing of a steel sheet according to claim 6, wherein the copper alloy wire is a solid wire having a cross-section that is solid and is homogeneous.

11. The method of gas-shielded arc brazing of a steel sheet according to claim 6, wherein the method is a method for gas-shielded arc brazing of a joint in which steel sheets are laid one upon another, wherein a heat input amount Q satisfies the following conditional expression determined according to a sheet thickness of a steel material to be joined:
625×t+125≦Q≦1,250×t+250 (J/cm)
where t is a sheet thickness (mm) of a steel sheet.

12. The method of gas-shielded arc brazing of a steel sheet according to claim 11, wherein an average welding current is from 60 to 150 A.

13. The method of gas-shielded arc brazing of a steel sheet according to claim 11, wherein the steel sheet has a sheet thickness of 0.6 to 1.4 mm.

14. The method of gas-shielded arc brazing of a steel sheet according to claim 6, wherein the steel sheet is a zinc coated steel sheet.
